(19) United States
(12) Patent Application Publication
(10) Pub. No.: US 2025/0381589 A1
(43) Pub. Date: Dec. 18, 2025

(54) STORAGE SYSTEM AND STORAGE CONTAINER

(71) Applicant: Ocado Innovation Limited, Hatfield (GB)

(72) Inventors: Alastair AUBUSSON, Hatfield (GB); Ashan FERNANDOPULLE, Hatfield (GB); Mark HOBBS, Hatfield (GB); Neil BAYLISS, Hatfield (GB)

(21) Appl. No.: 19/242,694

(22) Filed: Jun. 18, 2025

Related U.S. Application Data
(63) Continuation of application No. PCT/EP2023/087342, filed on Dec. 21, 2023.

(30) Foreign Application Priority Data
Dec. 22, 2022 (GB) 2219513.5

(51) Int. Cl. B21D 22/20; B21D 22/26; B21D 22/30; B21D 43/00; B21D 51/52; B65G 1/02; B65G 1/04

(52) U.S. Cl. CPC B21D 22/206; B21D 22/26; B21D 22/30; B21D 43/003; B21D 51/52; B65G 1/026; B65G 1/0464; B65G 1/0478

(57) ABSTRACT

A method of manufacturing a storage container for storage in a stack in a grid framework structure comprising a plurality of storage columns, each of the plurality of storage columns being configured to store a stack of storage containers. The method comprises the steps of: forming a lower part of the storage container by the steps of: stamping or drawing a sheet metal blank into a drawing die to form a tray-shaped preform comprising a base with a raised rim and a flange; turning the flange to define a connection surface that extends in the same direction as the raised rim of the tray-shaped preform to form a container having a predefined depth; forming an upper part of the storage container by the step of: stamping sidewalls and/or end walls from one or more separate sheet metal blanks; attaching the lower part to the upper part by attaching the sidewalls and end walls to the connection surface of the container.

### TECHNICAL FIELD

The present invention relates to the field of storage systems comprising load handling devices operative on tracks located on a grid framework structure for handling storage containers stacked in the grid framework structure, and storage containers for use in such storage systems.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIGS. 1 and 2, the storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 11. Each grid in the grid framework structure has at least one storage column 11 for storage of a stack of containers. FIG. 1 is a schematic perspective view of the grid framework structure 14, and FIG. 2 is a top-down view showing a single stack 12 of containers 10 arranged within the framework structure 14. Each container or bin 10 typically holds a plurality of product items (not shown), and the product items within a container 10 may be identical or may be of different product types depending on the application. Each container 10 may be used to store grocery items (i.e. food items), for example. Furthermore, the bins 10 may be physically subdivided to accommodate a plurality of different inventory items.

The grid framework structure 14 comprises a plurality of upright members or upright columns 16 that support horizontal members 18, 20. A first set of parallel horizontal grid members 18 is arranged perpendicularly to a second set of parallel horizontal grid members 20 to form a grid structure lying in a substantially horizontal plane and supported by the upright members 16. The members 16, 18, 20 are typically manufactured from metal and typically welded or bolted together or a combination of both. The storage containers 10 are stacked between the upright members 16 of the grid framework structure 14, so that the grid framework structure 14 guards against horizontal movement of the stacks 12 of the storage containers 10, and guides vertical movement of the storage containers 10.

The top level of the grid framework structure 14 includes a track system 15 comprising a plurality of rails or tracks 22 arranged in a grid pattern across the top of the stacks 12. Referring additionally to FIG. 3, the rails 22 support a plurality of load handling devices or robotic load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. The track system 15 can be integrated into the grid structure in the sense that the first and second sets of tracks are respectively integrated into the first and second set of grid members. Alternatively, the track system 15 can be separate to the grid structure in the sense that the first and second sets of tracks are respectively mounted to the first and second sets of grid members.

Each load handling device 30 comprises a vehicle body 32 which is arranged to travel in the X and Y directions on the tracks or rails 22 of the grid frame structure 14, above the stacks 12 (see FIG. 4). FIGS. 4 and 5 shows a load handling device 30 described in PCT Patent Publication No. WO2015/019055 (Ocado Innovation Limited) and International patent application WO 2015/140216 (Ocado Innovation Limited) comprising a vehicle body 32 equipped with a lifting mechanism 33 comprising a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame.

To grab a container 10, the grabber device 39 comprises four locating pins or guide pins 42 nearby or at each corner of the grabber device 39 which mate with corresponding cut outs or holes 44 formed at four corners of the storage container 10 and four gripper elements 46 arranged at the bottom side of the grabber device 39 to engage with the rim 48 of the storage container 10 (see FIG. 6). The locating pins 42 help to properly align the gripper elements 46 with corresponding holes 49 in the rim 48 of the container. In an example shown in FIG. 7a, each of the gripper elements 46 comprises a pair of wings 50 that are collapsible to be receivable in corresponding holes 49 in the rim 48 of the storage container and an open enlarged configuration having a size greater than the holes 49 in the rim 48 of the storage container 10 in at least one dimension so as to lock onto the storage container 10 (see FIG. 7b). The wings are driven into the open configuration by a drive gear (not shown). More specifically, the head of at least one of the wings comprises a plurality of teeth that mesh with the drive gear such that when the gripper elements 46 are actuated, rotation of the drive gear causes the pair of wings to rotate from a collapsed configuration (FIG. 7a) to an open enlarged configuration (FIG. 7b).

The vehicle body 32 comprises an upper part and a lower part (see FIGS. 5 (a and b)). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly that is are driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism comprising a winch, as shown in FIGS. 5 (a and b). When in the recess, the container is lifted clear of the rails beneath, so that the load handling device can move laterally to a different location. Whilst the container receiving space 40 is shown in FIG. 4 arranged within the vehicle body 32, the container receiving space can be located below a cantilever as described in WO2019/238702 (Autostore Technology AS).

On reaching the target location, for example another stack, an access point in the storage system or a conveyor belt, the bin or storage container can be lowered from the container receiving space and released from the grabber device 39. In this way, one or more robotic load handling devices 30 can move around the top surface of the stacks 12 on the frame structure 14, as shown in FIG. 3 under the control of a centralised control utility (not shown). Each robotic load handling device 30 is provided with a lifting mechanism 33 for lifting one or more bins 10 from the stack 12 to access the required items stored therein.

The robotic load handling devices 30 remove bins 10 containing inventory items (not shown) therein and transport the bins 10 to pick stations (not shown) where the required inventory items 28 are removed from the bins 10 and placed into bins 10 comprising delivery containers

DT. It is important to note that a delivery container DT may fit within a bin 10. The bins 10 may comprise inventory items or may comprise delivery containers DT. Furthermore, the delivery containers DT may comprise at least one bag, the inventory items being picked directly into a bag at a pick station (not shown).

A typical storage and retrieval system 1 is shown in FIG. 3, the system having a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12. Typically, each bin 10 must be able to bear the load of multiple bins 10 in a stack. The bin stack load is carried by the maximum load of twenty fully loaded bins. The weight of a fully loaded bin is about 35 kg, of which 5 kg represents the weight of the bin alone. For example, a stack of twenty bins 10 would represent a load of 700 kg or 6,867 N. The one or more ribs on the opposing sidewalls and end walls strengthens the sidewalls and end walls so as to prevent sidewalls and end walls buckling under such a load in a stack.

Typically, the bins 10 are largely composed of a thermoplastic material and are either injected moulded or blow moulded. Known thermoplastic material commonly used in the moulding of the storage containers comprises a polyolefin, e.g. polypropylene or polyethylene, (e.g. high density polyethylene (HDPE)), acrylonitrile butadiene styrene (ABS) and polycarbonate including copolymers thereof. However, the problem with such plastic materials is that they are flammable and emit toxic fumes. Once a fire has started within the storage and retrieval system, the flammable and exothermic nature of the material of the bins 10 would result in the fire spreading throughout the storage and retrieval system with a danger to life. Not only are the bins 10 flammable but the combustion fumes emitted from the burning thermoplastic material are highly toxic comprising benzene, which is a known carcinogen. Inhalation of fine particles as a result of the burning debris may cause respiratory irritation. As a result, extreme fire precaution methods and systems are incorporated into the storage and retrieval system to prevent the rapid spread of fire, such as sprinklers and smoke/heat detection units. Whilst efforts have been made to prevent the rapid spread of fire, of which the bins 10, play a major role in the spread of the fire, there is still the problem of fire spreading throughout the storage and retrieval system. Not only should the storage container be fireproof but should have sufficient structural rigidity to be able to be stacked one on top of the other in a storage and retrieval system. Typically, a fully loaded storage container weighs up to 35 kg. 30 kg represents the weight of the stock or items and 5 kg is the typical weight of the storage container. For a stack comprising twenty fully loaded storage containers, the load a storage container in a stack would have to bear would be 700 kg (6,867 Newtons).

WO2022/161863 (Autostore Technology AS) teaches a storage container for an automated storage and retrieval system. The storage container being configured to be stacked in a stack of storage containers where an underlying storage container supports the storage container(s) (106) positioned above. The storage container comprises: a base; four sides, each hingedly connected to an edge of the base by a live hinge. Four corner posts are configured to interconnect a pair of adjacent sides to each other in a horizontal direction when the sides are positioned substantially 90 degrees relative the base and relative each other. The base and sides of the storage container comprises a sheet metal material, the sheet metal material having been provided as a blank from which the base and four sides have been formed. However, WO2022/161863 (Autostore Technology AS) does not address the problem of providing a leak proof storage container, particularly where the contents of the storage containers are grocery or food items which are susceptible to spillage with the potential of contaminating other grocery items in the storage container or an adjacent storage container in a stack.

A fireproof storage container is thus required that is able to be stacked in a storage and retrieval system and yet does not suffer from the problem of leakage when storing food items.

### SUMMARY OF THE INVENTION

The present invention has mitigated the above problem by forming the storage container comprising a container or tray formed as a single unitary body to capture any leaks as a result of spillage from any of the contents of the storage container. As the container is formed as a single unitary body, the container can be defined as a single body container. The advantage of forming the base portion of the storage container as a single unitary body is that it provides greater assurance to be leak proof rather than relying on the connections between the walls of the storage container to be leak proof. The single body container forms a base portion or a lower part of the storage container and offers the best protection against leakage. Sidewalls and end walls are subsequently attached to the base portion to form an upper part of the storage container. The upper part of the storage container confines the contents of the storage container within the boundary of the storage container and prevents the contents from spilling out of the storage container. Assembly of the lower part comprising the container to the upper part comprising the sidewalls and end walls form a box like structure having a predefined depth.

Processing methods in the fabrication of the container include stamping or punching a single sheet metal blank by a forming die corresponding to the shape of the container or drawing a sheet metal blank into the forming die. In both forming methods, the sheet metal blank plastically deforms by the mechanical action of the forming die particularly in the region around the corners of the container. The degree of plastic deformation by the stamping or drawing process is very much dependent on the sharpness of any angles formed in the container or being formed to a very small radii. In the case where the container is substantially rectangular, plastic deformation of the sheet metal blank largely occurs around the corners of the container. The sharper the corner of the container, in the sense of being formed into a substantially 90° corner, the greater the plastic deformation since the sheet metal blank would be subject to more stretching or elongation in comparison to other areas of the container, e.g. the wall portions of the container. One of the negative consequences of plastic deformation during the forming process is wrinkling of the sheet metal, particularly in the region around the corners. In a worst case scenario, the stretching of the sheet metal at the corners of the container can overly exceed the yield strength of the sheet metal resulting in localised thinning of the sheet metal wall to the extent that the sheet metal can tear or rip, i.e. reach the rupture point of the sheet metal. Overly exceeding the yield strength of the sheet metal during the forming process is particularly problematic when cold drawing the sheet metal blank since the ductility of metal decreases at lower temperatures. Cold working the sheet metal blank tends to be the most preferable forming operation due to lower number of operations needed to work the sheet metal blank and the speed of manufacture of the storage container. Considering that a typical grid framework structure can hold thousands of storage containers, the cost and speed in the manufacture of the storage containers is very much a determinative factor in the running cost of a storage and retrieval system. As a result, a fabrication method is required that limits the number of processing steps in the fabrication of the storage containers.

To overcome the limitations of cold working a sheet metal blank into a predefined shape, typically the sheet metal blank is plastically deformed at elevated temperatures to increase the plasticity of the sheet metal blank by a process known in the art as superplastic forming (SPF). Superplasticity in metals is defined by high tensile elongation and having the ability to undergo extreme elongation at a certain temperature and strain rate. Usually, this involves heating the sheet metal blank to elevated temperatures to increase the plasticity of the metal. Thus, superplastic forming is used to produce parts that are difficult to form using conventional cold working processes. However, the use of superplastic forming to fabricate the storage containers tends to require a relatively high forming cycle time, which can be as high as 30 minutes. Considering that storage containers have to be manufactured on a mass scale, such forming techniques would not be ideal in forming the storage container for use in a storage and retrieval system.

Where the storage and retrieval system is for the storage of food items, it is essential that there is sufficient depth in the container to capture any spillage from foodstuffs. Spillages can be the result of meat juices, beverages or other liquid exuding from the stored food items etc. As a result of spillages, the recommended leakage capacity or leak proof capacity of the storage container for capturing any leakage from food items is about 20-30 litres. Considering that a typical storage container used in a storage and retrieval system has a dimension of 648 mm long, 448 mm width, and 362 mm high, to capture and retain 20-30 litres of fluid, this amounts to a container having a depth in the range 90 mm to 95 mm. As the depth of the container is much less than the length and width of the container, the container is formed into a shallow container.

The amount of plastic deformation that the sheet metal blank experiences increases as the depth of the container increases since more force is required to draw the sheet metal blank to a greater depth. However, it is preferable that the walls of the container are substantially uniform rather than having localised thinning in one or more areas of the storage container resulting in weakening of the storage container. An obvious solution in providing a container with sufficient leakage capacity would be to form the container with more rounded corners to reduce the amount of excessive plastic deformation that the sheet metal experiences during the forming process. However, one of the main requirements of a storage container for use in a storage and retrieval system is the ability of the storage container to be stacked in storage columns in the grid framework structure so as to enable a robotic load handling device operational on the grid framework structure to engage and lift a storage container from a stack or storage containers. When stacking storage containers in the grid framework structure, it is essential that the base or bottom wall of the storage container sits on the rim of an adjacent storage container below in the stack so as to enable a load handling device operational on the grid framework structure to properly engage with the storage container. For a grabber device of a load handling device to properly engage with a storage container in a stack, it is important that the storage container is level. For a storage container to be level in a stack, ideally the base or lower part of the storage container should sit squarely on the rim of a storage container below in the stack. As the container forms the lower part of the storage container, forming the container with more rounded corners suffers from the problem that one or more of the corners of the storage container would not sit squarely on the rim of an adjacent storage container below in the stack and in a worst case scenario fall into the mouth of the storage container below in the stack. Considering that a stack can hold as many as twenty one storage containers, any one of the storage containers that has failed to properly sit on the rim of an adjacent storage container below in the stack has the potential of causing some of the storage containers to get stuck together. This in turn would prevent a load handling device operative on the grid framework structure to properly engage with the storage container and if engaged with the storage container, properly separate a storage container from an adjacent storage container in the stack. One solution would be to draw the sheet metal blank multiple times to different depths by transferring the drawn part to different drawing dies of increasing depth. However, this not only increases the number of processing steps in the fabrication of the storage container, the repeated transfer of the drawn part to different dies does not lend itself kindly to automation of the fabrication process. Moreover, this also increases the risk of damage to the drawn part each time the drawn part is transferred to another die due to the need to continuously remove the drawn part from a previous die in the fabrication process.

To provide a storage container formed from a container with the correct depth for the purpose of providing a leak proof storage container and be able to be stacked without suffering from the problems discussed above, the lower part of the storage container according to the present invention is formed from at least a two stage process. More specifically, the present invention provides a method of manufacturing a storage container for storage in a stack in a grid framework structure comprising a plurality of storage columns, each of the plurality of storage columns being configured to store a stack of storage containers, the method comprising the steps of:
A) forming a lower part of the storage container by the steps of:
   i) stamping or drawing a sheet metal blank into a drawing die to form a tray-shaped preform comprising a base with a raised rim and a flange;
   ii) turning the flange to define a connection surface that extends in the same direction as the raised rim of the tray-shaped preform to form a container having a predefined depth;
B) forming an upper part of the storage container by the step of:
   iii) stamping sidewalls and/or end walls from one or more separate sheet metal blanks;
C) attaching the lower part to the upper part by attaching the sidewalls and end walls to the connection surface of the container.

Stamping or drawing a sheet metal blank into a drawing die or forming die to form a tray shaped preform comprising a base or bottom wall with a raised rim and a flange followed by turning the flange to form a container having a predefined depth allows the container to be formed by a cold working process with a predefined leakage capacity. As a result, the container can be formed to a given depth without unduly exceeding the rupture point of the sheet metal particularly at the corners of the container. Cold forming the sheet metal blank to form a tray shaped preform can be used to the extent that the rupture point of the sheet metal is not reached or exceeded when forming the tray-shaped preform with a tight radii, particularly at the corners. Rather than drawing the tray-shaped preform again to a deeper depth, to increase the leakage capacity of the tray-shaped preform, the flange is turned to increase the depth of the tray-shaped preform. The flange is turned at the junction between the raised rim and the flange of the tray-shaped preform to increase the depth of the tray-shape preform. The combination of the stamping/drawing process and turning the flange enables the container to be formed with sharp corners and having the required leakage capacity for holding liquids that would not be possible if the container was entirely stamped or drawn in a single operation to the predefined depth from a single cold sheet metal blank. Optionally, the corners of the tray-shaped preform is rounded having a radius in the range 5 mm to 10 mm, more specifically in the range 5 mm to 8 mm. Optionally, the sheet metal blank has a thickness in the range 0.5 mm to 1.0 mm.

The drawing process relates to a process where a sheet metal blank is drawn into a die cavity by the mechanical action of a punch. The drawing die comprises a holder die member, an upper die member and a lower die member, at least one of the upper and lower die members comprising a punch and the opposite die member comprising a die cavity. Optionally, the method further comprises the step of using the holder die member with the punch to control the amount of the sheet metal blank being drawn into the die cavity.

As a result of the drawing process, the flange extends outwardly around the peripheral open edge of the raised rim. To turn the flange to define a connection surface for connection with the sidewalls and end walls in the upper part of the storage container, preferably, the flange is turned by inwardly turning the flange so that the flange extends in the same direction as the raised rim of the tray-shaped preform.

During the drawing process, the sheet metal blank is clamped in the holding die member and a punch is mechanically drawn into the sheet metal which results in the sheet metal blank taking the shape of the punch comprising a raised rim. One of the consequences of drawing a sheet metal blank is the stretching of the sheet metal as the amount of sheet metal is increasingly drawn into the die cavity. The stretching results in flashing or flash around the holding die and extending from the raised rim. The flash can be of variable length depending on the stretching experienced by the sheet metal in the die cavity. Optionally, the method further comprises the step of trimming the flash to form the flange by a trim cutting die comprising a trim cutting punch and a location die member for supporting the tray-shaped preform, wherein the flash is trimmed by moving the trim cutting punch relative to the location die member to form the flange. Optionally, the trim cutting punch can be integrally formed with the drawing die, e.g. part of the die cavity. Integrating the trim cutting punch into the die cavity enables the flash trimming to be carried using the same tool as the drawing die. Thus, the punch for drawing the sheet metal blank into the tray-shaped preform can function as a holding die member for supporting the tray-shaped preform and the trim cutting punch integrated into the die cavity subsequently trims the flash to form the flange for turning. Optionally, trimming the flash can be carried out in a separate tool. Thus, the method can comprise the steps of: transferring the tray-shaped preform to a trim cutting die comprising a trim cutting punch and a location die member for supporting the tray-shaped preform, wherein the method further comprises the step of trimming the flash by moving the trim cutting punch relative to the location die member to form the flange.

The rate and the amount of sheet metal that is drawn into the die cavity varies depending on the shape of the die cavity. For a cuboidal shaped die cavity, a greater proportion of the sheet metal is drawn into the sides and ends of the tray-shaped preform in comparison to the corners of the tray-shaped preform. This results in an uneven flash around the peripheral open edge of the rim of the container, particularly at the corners of the flange. This is as a result of greater material flow at the corners of the flange during the turning process. The method further comprises the step of trimming the corner of the flash by a trim corner cutting die comprising a corner cutting punch and a location die member for supporting the tray-shaped preform, wherein the corner of the flash is trimmed by moving the corner cutting punch relative to the location die member. Like the trim cutting punch, optionally, the corner cutting punch is integrally formed with the drawing die. Alternatively, the corner trimming of the flash can be carried out in a separate tool. Thus, optionally, the method further comprises the step of transferring the tray-shaped preform to a trim corner cutting die comprising a corner cutting punch and a location die member for supporting the tray-shaped preform, wherein the method further comprises the step of trimming the corner of the flash by moving the corner cutting punch relative to the location die member.

The phrase “turned” covers the process of bending the sheet metal at the junction between the raised rim and the flange so that it lies in a vertical plane, thereby, increasing the depth of the tray-shaped preform. Optionally, the flange is turned by the steps of:
i) surrounding the tray-shaped preform by a wiping die such that the flange extends at least partially across the wiping die;
ii) moving the wiping die relative to the tray-shaped preform to turn the flange.

An example of turning the flange on an industrial scale is by the use of a wiping die (also known as edge bending) comprising a location die member and a wiping die member. The method comprising the steps of:
i) holding the pre-shaped preform in the location die member such that the flange extends outwardly from the location die member;
ii) moving the wiping die member relative to the location die member to turn the flange. Optionally, the wiping die member is integrally formed with the drawing die such that the wiping process of the flange can be carried out using the same tool as the drawing process.

Alternatively, the wiping process can be carried out in a separate wiping tool by the method of:
i) transferring the tray-shaped preform to a wiping die comprising location die member and a wiping die member such that the wiping die member extends outwardly from the location die member,
ii) moving the wiping die member relative to the location die member to turn the flange.

Depending on the shape of the storage container, the wiping die member can be built up as separate wiping die components, each of the separate wiping die components can be adapted to turn at least a portion of the flange of the tray-shaped preform. Considering that the flange extends around the peripheral open edge of the rim, optionally, the wiping die member can be ring shaped so as to surround the tray-shaped preform such that movement of the wiping die member relative to the location die member effectively turns the flange protruding from the location die member in one operation. The wiping die member may also be substantially rectangular. In this case, the wiping die member may surround the container, particularly if the cross-section of the container is substantially rectangular.

As the sidewalls and/or end walls are connected to the lower part of the storage container by connection to the connection surface that is formed by turning the flange, it is important that there is maximum contact surface area between the connection surface in the lower part of the storage container with the sidewalls and/or end walls in the upper part of the storage container, particularly at the corners of the storage container. One of the problems with turning the flange to define a connection surface for connecting to the sidewalls and/or end walls is that any deformity or wrinkling of the flange inhibits proper connection between the connection surface and the sidewalls and/or end walls, particularly at the corners of the storage container. For example, the flange, particularly at the corners, is prone to wrinkling to relieve any plastic flow of metal during turning of the flange. As a result, maximum surface contact between the sidewalls and/or end walls and the connection surface at the corners is limited by the wrinkling of the flange. To mitigate this wrinkling during the turning process, optionally, the step of trimming the corner of the flash by the trim corner cutting die comprises the step of forming a notch in the corner of the flange. Various shaped notches can form in the corner of the flange. These include but are not limited V-shaped, U-shaped or semi-circular shaped. The depth of the notch is such that excess metal flowing at the corner during turning of the flange is accommodated by the space occupied by the notch resulting in a more smoother contact surface and thereby, maximising the surface contact between the flange and the upper part of the storage container, namely the sidewalls and the end walls.

Optionally, the method further comprising the step of stamping a step into the flange. Forming a step in the flange provides a seat in the flange for supporting an edge of the sidewalls and end walls of the upper part of the storage container when the sidewalls and end walls are offered up to the connection surface. Moreover, the step in the flange enables the sidewalls and end walls in the upper part of the storage container to be angled outwardly relative to the raised rim of the container. This has the effect of forming the storage container with outwardly tapered or inclined sidewalls and end walls. Subsequent to forming the container with the required leakage capacity, the storage container is formed by attaching the sidewalls and end walls to the flange via its connection surface. Optionally, the sidewalls and end walls are attached to the connection surface by welding.

Optionally, the sidewalls are connected to the end walls by their respective edges to form a corner of the storage container. Specifically, opposing edges of each of the sidewalls are connected to opposing edges of respective end walls. As one or more of the storage containers are stored in the grid framework structure in one or more stacks, it is essential that each of the storage containers has sufficient structural integrity to bear the weight of one or more storage containers in a given stack. For example, a given stack in storage in the grid framework structure can be as high as twenty storage containers. Considering that each of the storage containers can weigh up to 35 kg, this amounts to a weight of 700 kg. Without the necessary structural integrity in the walls of the storage container, there is the danger that the walls of the storage container would collapse under the weight of one or more storage containers above in the stack. The art, WO2022/161863 (Autostore Technology AS), has mitigated this problem by the provision of four separate corner posts interconnecting adjacent sides of the storage container. Whilst the provision of corner posts provides the storage container with sufficient structural integrity to bear the weight of one or more storage containers in a stack, the interconnection between the corner posts and the sides of the storage container does not itself kindly to providing a leak proof storage container. This is because for the storage container taught in WO2022/161863 (Autostore Technology AS) to be leak proof, it is important that the interconnections between the corner posts and sides of the storage container is leak proof. However, complications arise when trying make the connection between separate parts leak proof as it is very much dependent on the type of connection that is used.

To remove the need to have separate corner posts to interconnect the sides of the storage container, optionally, each of the sidewalls and end walls comprises a connecting flange that are configured to overlay at the corners of the storage container when each of the sidewalls is connected to the respective end wall. Overlaying portions of the sidewall and end wall at the corners of the storage container reinforces the corners of the storage container without the need to have separate corner posts. The double skin formed from the connecting flanges at the corners of the storage container provide sufficient structural rigidity at the corners of the storage container to provide a load bearing structure. Having a connecting flange at opposing ends or edges of the sidewalls and end walls of the storage container reinforces the storage container at the four corners of the storage container. The connecting flange can be integrally formed during stamping of the sidewalls and end walls from the one or more separate sheet metal blanks. To further increase the structural rigidity of the storage container, optionally, the upper part of the storage container further comprises sidewall and/or end wall rim portions, each of the sidewall rim portions being configured to be fitted to a respective sidewall and/or each of the end wall rim portions being configured to be fitted to a respective end wall. To further increase the structural rigidity of the storage container, particularly at the corners of the storage containers, optionally, each of the end wall rim portions comprises downwardly extending rim flanges, each of the downwardly extending rim flanges being configured to overlay the connecting flange of a respective end wall when the end wall rim portions are fitted to the end walls. The downwardly extending rim flanges overlaying the connecting flanges at the corners of the storage containers increases the structural rigidity of the storage container by increasing the number of ‘skins’ of sheet metal at the corners of the storage container from a double skin to a triple skin.

To enable a storage container to engage with a grabber device of a load handling device, optionally, the storage container is adapted to be lifted by the end wall and/or the sidewall of the storage container. Optionally, each of the sidewalls and/or end walls comprises one or more openings or depressions for engagement with a grabber device of a load handling device.

To plastically deform the sheet metal blank when being drawn into a forming die, the tray-shaped preform is stamped or drawn from the sheet metal blank comprising galvanised steel. Galvanized steel is more ductile, and easier to work than alternative corrosion resistant steels such as stainless steel. Stainless steel is stronger and more corrosion-resistant than galvanized steel but suffers from the problem of lower ductility in comparison to galvanised steel.

To increase food safety with the use of galvanised steel, the storage container can be lined with a liner that is compliant to food safety standards. In this case, the storage container is formed as a metal container body that is lined with a liner. Optionally, the storage container comprises a liner formed from a food grade material. Optionally, the liner comprises a food grade plastic material and/or cellulose base material.

The present invention provides a storage container for the storage of one or more items in a storage and retrieval system comprising a track system comprising a first set of parallel rails or tracks and a second set of parallel rails or tracks running transversely to the first set of parallel tracks in a substantially horizontal plane to form a grid pattern comprising a plurality of grid spaces or grid cells and a plurality of stacks of storage containers located beneath the track system and wherein each stack of the plurality of stacks of storage containers occupies a single grid space or grid cell, the storage container comprising a metallic container body formed by the method according the present invention.

The present invention further provides a storage and retrieval system comprising:
i) a grid framework structure comprising a plurality of storage columns for the storage of one or more stacks of storage containers and a track system comprising a plurality of tracks arranged in a grid pattern comprising a plurality of grid cells, the track system being arranged above the plurality of storage columns such that each of the plurality of storage columns is arranged below a respective grid cell of the track system;
ii) one or more stacks of storage containers, wherein at least one of the storage containers in the one or more stacks of storage containers being formed by the method according to the present invention;
iii) a plurality of load handling devices for lifting and moving storage containers stacked in the one or more stacks, the plurality of load handling devices being remotely operated to move laterally on the track system 106 above the storage columns to access the storage containers through the grid cells, each of said plurality of load handling devices comprising:
a) a wheel assembly for guiding the load handling device on the track system;
b) a container-receiving space located above the track system; and
c) a lifting device arranged to lift a storage container from a stack into the container-receiving space.

### BRIEF DESCRIPTION OF DRAWINGS

Further features and aspects of the present invention will be apparent from the following detailed description of an illustrative embodiment made with reference to the drawings, in which:

FIG. 1 is an illustration of an automated storage and retrieval system according to an exemplary embodiment of the present invention.

FIG. 2 is a schematic diagram of a top down view showing a stack of bins arranged within the framework structure of FIG. 1.

FIG. 3 is a schematic diagram of a system of a known load handling device operating on the grid framework structure.

FIG. 4 is a schematic perspective view of the load handling device showing the container receiving space within the body of the load handling device.

FIGS. 5(a) and 5(b) are schematic perspective cut away views of the load handling device of FIG. 4 showing (a) a container accommodating a container receiving space of the load handling device and (b) the container receiving space of the load handling device.

FIG. 6 is a schematic perspective view of the grabber device positioned above the storage container.

FIG. 7(a) is a schematic perspective view of the grabber device mounted on the storage container.

FIG. 7(b) is a schematic perspective view of the grabber device engaging with the storage container.

FIG. 8 is a schematic perspective view of a storage container comprising a container base drawn from a sheet metal blank according to an embodiment of the present invention.

FIG. 9 is an exploded view of the storage container shown in FIG. 8.

FIG. 10 is a schematic perspective view of a sidewall of the storage container shown in FIG. 8 formed from a sheet metal blank.

FIG. 11 is a schematic perspective view of an end wall shown in FIG. 8 formed from a sheet metal blank.

FIG. 12 is a schematic perspective view of a rim portion of the storage container shown in FIG. 8.

FIG. 13 is a perspective expanded view of a corner of the storage container shown in FIG. 8 showing the double skin reinforcement from the overlapping sidewall and end walls flanges.

FIGS. 14(a and b) are schematic perspective views of (a) a rim portion of the storage container comprising downwardly extending rim flanges at opposing ends of the rim portion according to another embodiment of the present invention, (b) an end wall comprising flanges at opposing ends of the end wall that is configured to overlay the downwardly extending flanges when the rim portion is mounted to the end wall.

FIG. 15 is a schematic perspective cross-sectional view of a corner of the storage container assembled from the rim portion and end wall shown in FIGS. 14(a and b) reinforced with three skins of the sheet metal.

FIG. 16 is a schematic perspective view of a step in the manufacturing process illustrating the step of drawing a single sheet metal blank in a drawing die to form a leak proof container according to an example of the present invention.

FIG. 17 is a schematic perspective view of a tray-shaped preform formed by the drawing a sheet metal blank in a drawing die shown in FIG. 16.

FIG. 18 is a schematic perspective view of a step in the manufacturing process illustrating turning the flange by a wiping die according to an example of the present invention.

FIG. 19 is a schematic perspective view of a step in the manufacturing process illustrating the turned flange by the wiping die shown in FIG. 18 according to an example of the present invention.

FIG. 20 is a schematic perspective view of a step in the manufacturing process illustrating trimming the flash of the tray-shaped preform in the trim cutting die to form the flange.

FIG. 21 is a schematic perspective view of a step in the manufacturing process illustrating trimming the corner portions of the flash of the tray-shaped preform in the trim corner cutting die.

FIGS. 22(a and b) is a schematic perspective view of (a) the tray-shaped preform with the trimmed flange from the steps shown in FIGS. 20 and 21 extending outwardly in a substantially perpendicular direction to the raised rim and; (b) a container where the trimmed flange of the tray-shaped preform is turned so that it extends in the same direction as the raised rim.

FIG. 22(c) is a magnified view of the corner of the tray-shaped preform showing the radius, R, of curvature of the corner.

FIGS. 22(d and e) are schematic drawings of (d) the flange at the corner of the tray-shaped preform in absence of a notch; and (e) the flange at the corner of the tray-shaped preform with a notch.

FIG. 23 is a schematic perspective view of a step in the manufacturing process illustrating turning the flange of the tray-shape preform by the wiping die.

FIG. 24 is a schematic perspective view of a step in the manufacturing process illustrating the step of drawing a single sheet metal blank in a drawing die, turning the flange and trimming the flash in a single operation.

FIG. 25 is a schematic perspective view illustrating an assembly line comprising the assembly stations for assembling the storage containers according to an example of the present invention.

FIG. 26 is a flowchart illustrating the steps in the assembly of the storage container according to an example of the present invention.

### DETAILED DESCRIPTION

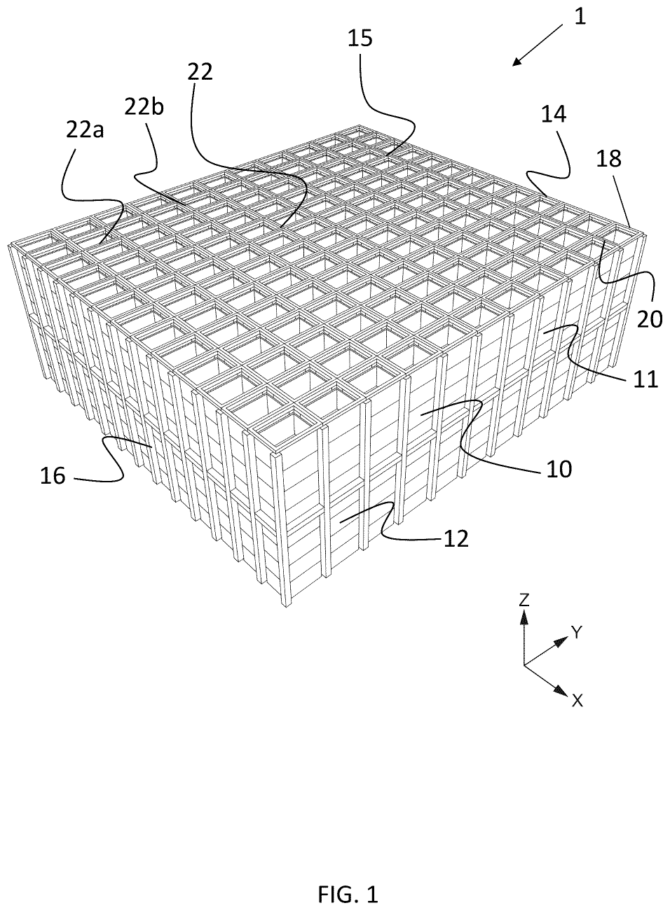

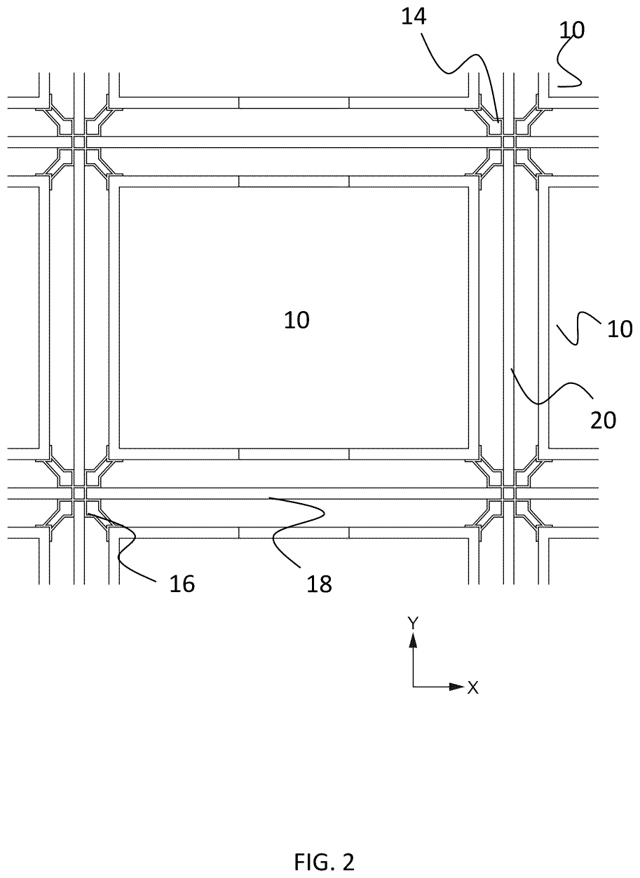

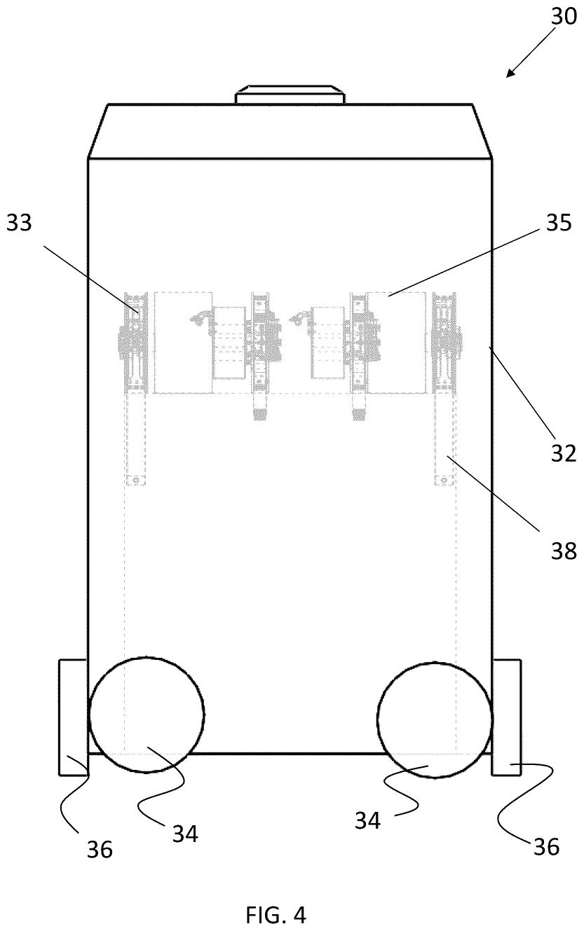

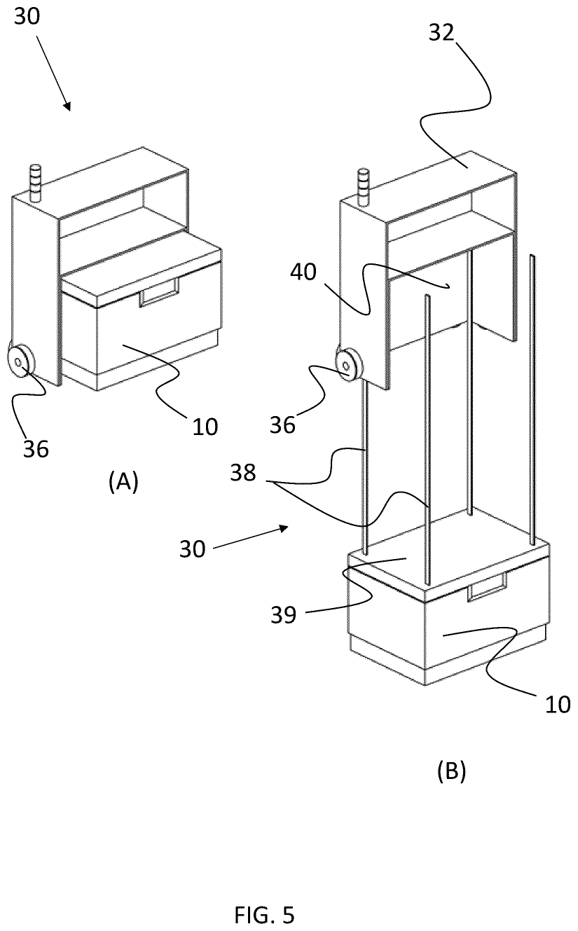

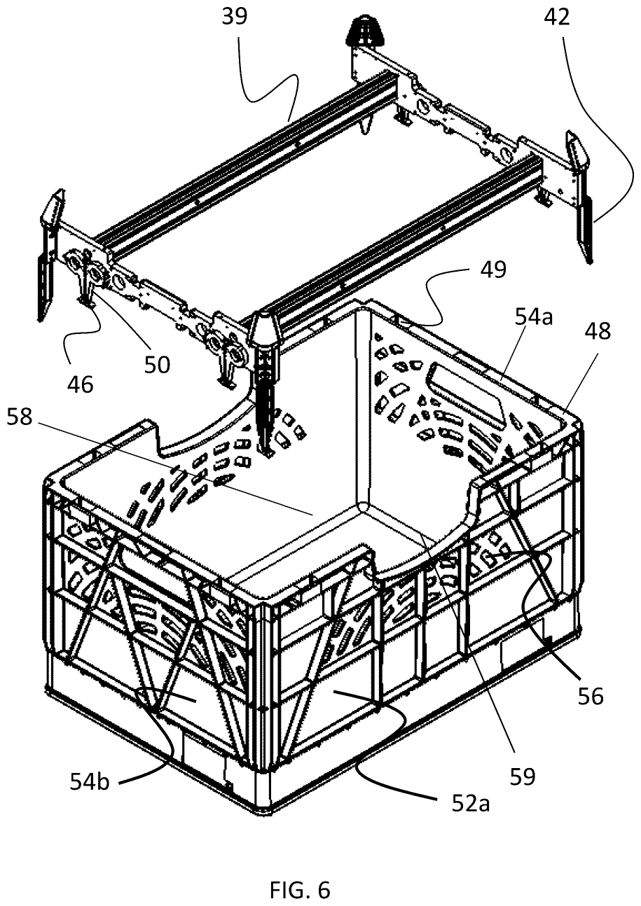

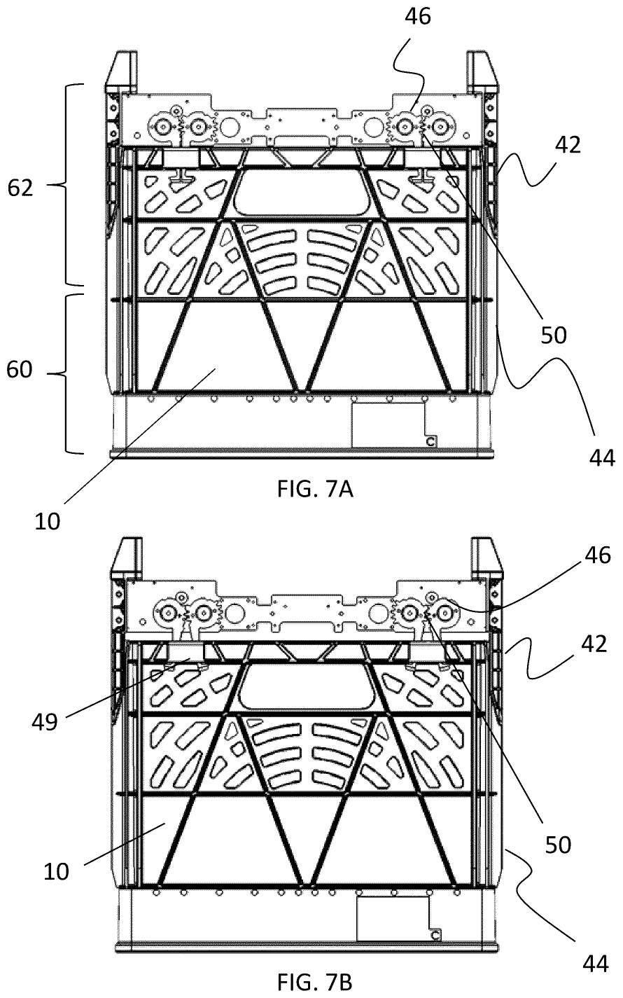

It is against the known features of the storage system such as the grid framework structure and the load handling device described above with reference to FIGS. 1 to 7(a and b), the present invention has been devised. FIGS. 6 and 7(a and b) are examples of a typical storage container for use to store items or goods in a grid framework structure. The storage container is generally cuboidal but other shapes of the storage container are applicable in the present invention. The storage container shown in the particular embodiment of the present invention has a substantially rectangular cross section. However, the present invention is not limited to having a rectangular cross-sectional shape and other cross-sectional shapes are applicable in the present invention, e.g. square. For storage in a grid framework, the storage container should have the following characteristics:
A. Have sufficient structural integrity to be able to be stacked in a storage column in a grid framework structure without any of the walls of the storage container deforming or changing shape.
B. Be lightweight in the sense that the weight of the storage container should ideally represent a small proportion of the weight of the contents of the storage container. Typically, the weight of a storage container in the art is about 5 kg to 8 kg. This is to prevent the lifting mechanism comprising a lifting motor being burdened by the weight of the storage container and also, allows a greater weight of contents to be stored in the storage container.
C. Be leak proof to prevent fluid as a result of spillages from items, particularly grocery items, stored in the storage container from escaping the storage container and contaminating the contents of other storage containers in the nearby vicinity.
D. Have relatively sharp corners or corners with a small radii so as to be able to be stacked one on top of the other in a storage column without any two of the storage containers in a stack getting stuck. Therefore, the storage container should comprise corners which ensure separation of the storage containers when being lifted by a load handling device operational on the grid framework structure.
E. Be fire resistant in the sense that the material of the storage container does not spontaneously combust and/or does not emit toxic fumes in an event of a fire.

Typically, the physical characteristics described above in points A to D are addressed by fabricating the storage containers from a thermoplastic material since such materials are lightweight and able to be able to be moulded into complex shapes. Examples of fabrication methods include but is not limited to injection moulding, blow moulding etc. As a result, the storage containers can be moulded with sharp corners so allowing storage container to be stacked without getting stuck, particularly where the storage container is supporting a stack of up to twenty one storage containers, each of the storage container having a total weight of about 35 kg. One of the common problems of not having sharp corners or corners with a tight radii is the risk that one or more corners of a storage container in the stack falling into the mouth 58 of an adjacent storage container below in the stack (see FIG. 6). This has the detrimental effect of any two storages getting stuck in a stack, thereby preventing the storage containers being separated when trying to lift one of the storage containers from the stack. In a worst case scenario, a load handling device operational on the grid framework structure is either prevented from lifting the storage container from the stack due to the corners fouling the vertical uprights of the grid framework structure or is forced to lift multiple storage containers is one lift due to them being stuck together. The problem of any two storage containers being stuck together is exacerbated when the grabber device of the load handling device fails to lower a storage container squarely on a storage container in a stack. This could be the result of any one of the lifting tethers connected to the grabber device used to engage with the storage container not being of equal length causing the grabber device to incline or tilt as it is being lowered and/or the swinging of the storage container as it is lowered down a storage column. To mitigate the possibility of any two storage containers getting stuck due to being improperly seated on an adjacent storage container below in a stack, it is essential that the storage container is formed with tight corners, ideally 90° corners so as to enable the storage containers to rest squarely on the rim of an adjacent storage container below in a stack. The ability to mould complex shapes from thermoplastic material allows storage containers to be formed with complex shapes, particularly tight corners as shown in FIGS. 6 and 7(a and b). Other advantages in the use of thermoplastic material when fabricating storage containers for use in a grid framework structure is the lightness of the material due to its inherent low density and being inherently leak proof. The low density of thermoplastic materials enables the walls of the storage container to be made thick enough to provide the necessary structural integrity to be stacked in the grid framework structure. The inherent leak proof characteristics of thermoplastic material would mean that the storage container moulded from a thermoplastic material is leak proof.

To allow air to flow within the storage containers 10 when held in a stack, the sidewalls 52 (a and b) and/or end walls 54 (a and b) of the storage containers 10 comprise one or more slots or openings or vent holes 56. The slots or openings 56 in the sidewalls 52 (a and b) and/or end walls 54 (a and b) allow air circulating within and around the storage and retrieval system to flow within the storage containers 10. This is particularly important in the case where the storage containers 10 are located in a chilled zone of the storage and retrieval system where cool air from a refrigerated or air conditioning unit is circulated around at least a portion of the grid framework structure for keeping items such as grocery items at a chilled temperature. Cooling systems such as that described in International Patent Publication No. WO2016/193419 (Ocado Innovation Limited) require air to flow within the storage system and through the storage containers 10 and stacks 12 of bins 10. The system described in this International Patent Application is hereby incorporated by reference and discloses a storage system comprising one or more heater and/or one or more chiller for generating temperature controlled gas, one or more fans for circulating the temperature controlled gas through the storage system; and a plenum for receiving the temperature controlled gas. Should a portion of the storage and retrieval system require cooling to a lower temperature, for example to enable storage of items requiring chilling, such as fruit and vegetables, it is more important that the air flow through the system cools the items to be stored. In addition to cooling the storage system, it will be appreciated that, using the same method described, the items stored in the storage system may be heated in a similar manner.

One of the important characteristics of storage containers when storing grocery items is to prevent leakage of food items escaping from the storage container and contaminating other food items stored in adjacent storage containers in a stack. Since fluid tends to settle at the base of the storage container, the storage container can be divided into having a lower part or base portion 60 and an upper part 62. Ideally, the lower part or base portion 60 of the storage container 10 is made leak proof to prevent leakage of liquid captured in the lower part of the storage container from escaping the storage container and the upper part 62 comprises the sidewalls and end walls to contain the goods within the storage container. Thus, any vent holes 56 for the passage of air in the sidewalls and end walls are formed in the upper part of the storage container to prevent fluid trapped in the lower part of the storage container from escaping through the vent holes. The general consensus in the industry is to fabricate a storage container with a capacity to capture about 20 litres to 30 litres of liquid without leaking (hereinafter referred in the description as leakage capacity or leak proof capacity). For example, for a storage container having dimensions of 448 mm by 648 mm by 362 mm, this amounts to the lower part of the storage container having a depth in the range 90 mm to 95 mm.

Whilst fabricating the storage containers from thermoplastic materials has significant advantages discussed above, a problem with the use of thermoplastic materials is that the material has the potential to thermally combust and emit toxic fumes in an event of a fire. The flammability of thermoplastic material is such that a fire in a localised area of the grid framework can rapidly spread to other areas of the grid framework structure due to the flammability of the storage containers. For example, excessive heat in the event of a fire in a localised area of the grid framework structure will cause one or more storage containers to melt causing molten plastic to drip onto other areas of the grid framework structure. Considering that there are multiple stacks of storage containers in a typical grid framework structure, a fire developed in one area of the grid framework structure could potentially set off a chain reaction as the fire spreads to other parts of the grid framework structure. The inherent flammability of the use of thermoplastic material has meant that alternative flame resistant materials would have to be used in the fabrication of the storage containers but still have the necessary physical characteristics described in points A to D above.

The choice of material for fabricating the storage container according to the present invention is metal since metal has the properties of being flame resistant. However, the storage container of the present invention is not limited to being entirely formed from a metallic container body and at least a portion of the storage container can comprise other materials, e.g. plastic material. The storage container comprising the metallic container body is also applicable to delivery containers (DTs) in the sense that the delivery container can also comprise a metallic container body of the present invention comprising a container bottom wall and opposing sidewalls and opposing end walls. In the description below, storage containers 10 will be used to denote the storage containers intended for the storage of inventory items, whilst delivery containers (DTs) will be used to denote containers filled or intended to be filled according to orders placed by customers. It will be appreciated that this terminology is used for ease of reference and explanation within this document. However, it should be noted that the storage container 10 and the DTs may be of the same shape, size and/or configuration. Furthermore, DTs may be stored in storage containers 10 within the storage system or any part thereof. To allow access to the delivery containers when nested in the storage containers, the opposing sidewalls and/or the opposing end walls of the storage containers can comprise a cut-out 59 such that when combined with a delivery container, the cut out 59 extends below the height of the delivery container.

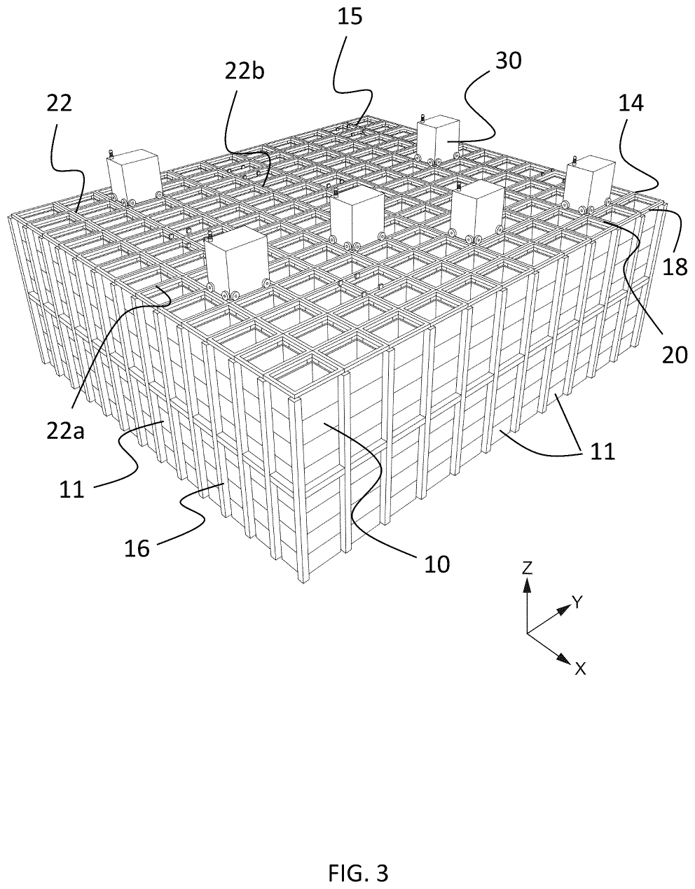

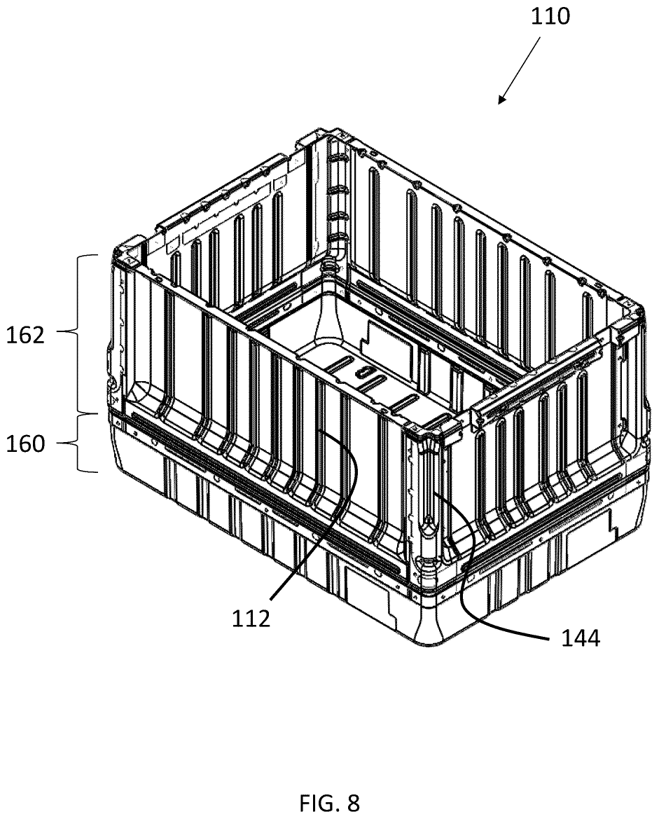

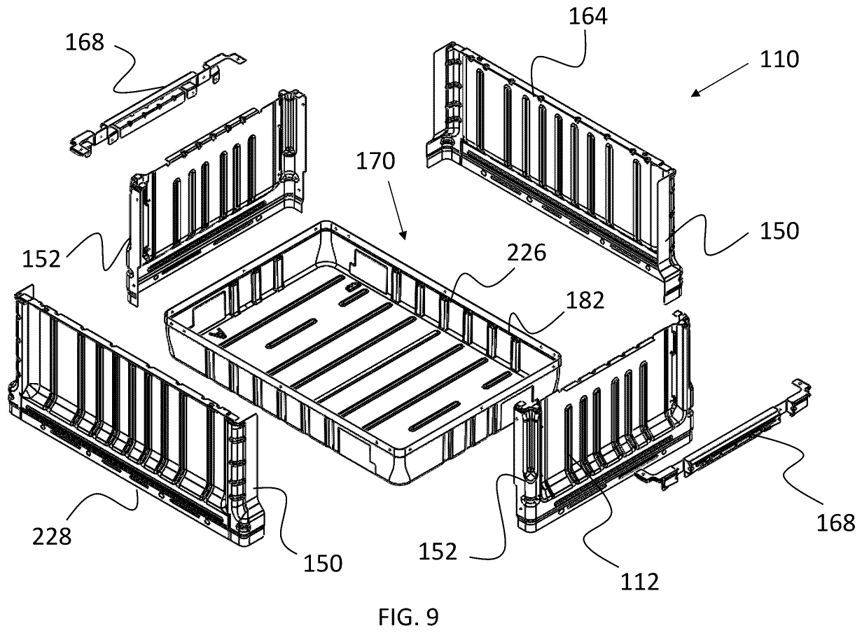

In the examples of the different types of storage containers discussed below with reference to FIGS. 8 and 9, the entirety of the body of the storage container is formed from metal in the sense that the metallic container body of the storage container will be defined as the storage container. This does not distract from the fact that the storage containers can comprise a liner. For food items, the liner can be formed from food grade material, e.g. food grade plastic material and/or cellulose base material (cardboard) impregnated with wax. For case of explanation, the metallic container body in the forthcoming examples can be referred to as storage containers. The metallic container body of the present invention can have a similar shape to the storage containers currently used for storing items in the grid framework structure, e.g. having a substantially rectangular container bottom wall and opposing side walls and end walls. The metallic storage containers can be used amongst the traditional plastic storage containers in the storage and retrieval systems described above with reference to FIG. 3 and FIGS. 6 and 7(a and b). The flame resistant behaviour of the metallic storage containers can be used to form a flame resistant barrier wall in the grid framework structure. For example, a plurality of stacks of metallic storage containers can be arranged to form one or more flame resistant barrier walls so as to at least partially surround a plurality of stacks of storage containers comprising plastic material. One or more flame resistant barrier walls comprising the metallic storage containers can be used to contain any flames within the grid framework structure.

FIG. 8 is an example of a storage container 110 fabricated from one or more sheet metal blanks according to the present invention and FIG. 9 is an exploded view of the storage container shown in FIG. 8. Like the storage container 10 currently used in practice, the storage container 110 according to the present invention can also be broken down to having a lower part or base portion 160 and an upper part 162. In comparison to forming the entirety of the storage container as a single unitary body having a lower part and an upper part, which is typically the case where the storage container is fabricated entirely from a plastic material, the storage container according to an exemplary embodiment of the present invention is assembled from separate lower and upper parts 160, 162. In the particular embodiment shown in FIG. 9, the walls in the upper part of the metallic container body are formed as separate parts, e.g.

by stamping or drawing from a plurality of sheet metal blanks, and are subsequently fixedly connected together to form the upper sidewall parts 164 and upper end wall parts 166. For the purpose of definition, the term “upper sidewall part” can be referred to as “sidewall” of the storage container and the term “upper end wall part” can be referred to as “end wall”. The upper sidewall parts 164 and/or the upper end wall parts 166 can comprise one or more cut-outs as shown in FIG. 6 to allow access to a delivery container (DT) nested in the storage container.

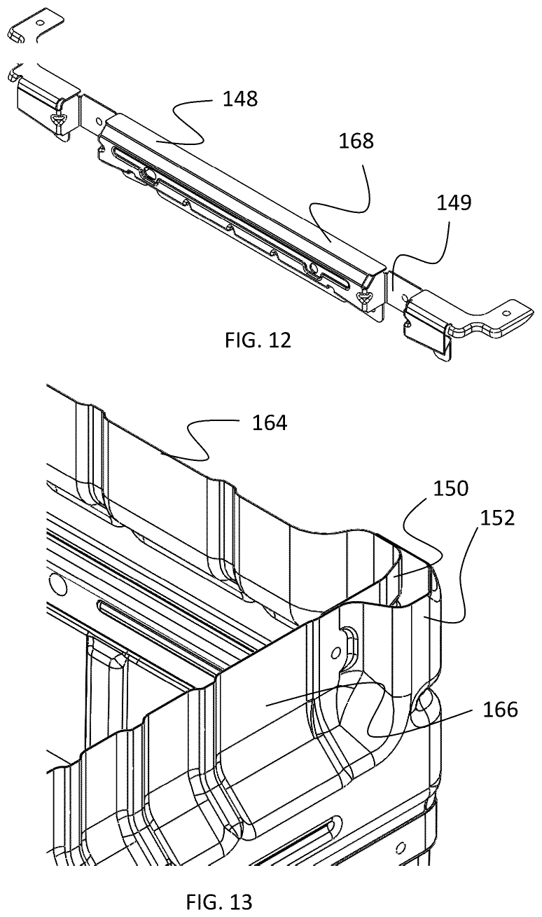

One or more separate rim portions 168 are mounted to the upper edge of the upper sidewall parts 164 and upper end wall parts 166 to define the rim of the metallic container body 110. The separate rim portions 168 are mounted to each of the upper sidewall parts 164 and/or the upper end wall parts 166. As shown in FIG. 12, the rim portions 168 comprise one or more openings or depressions 149 for engagement with a grabber device of a load handling device.

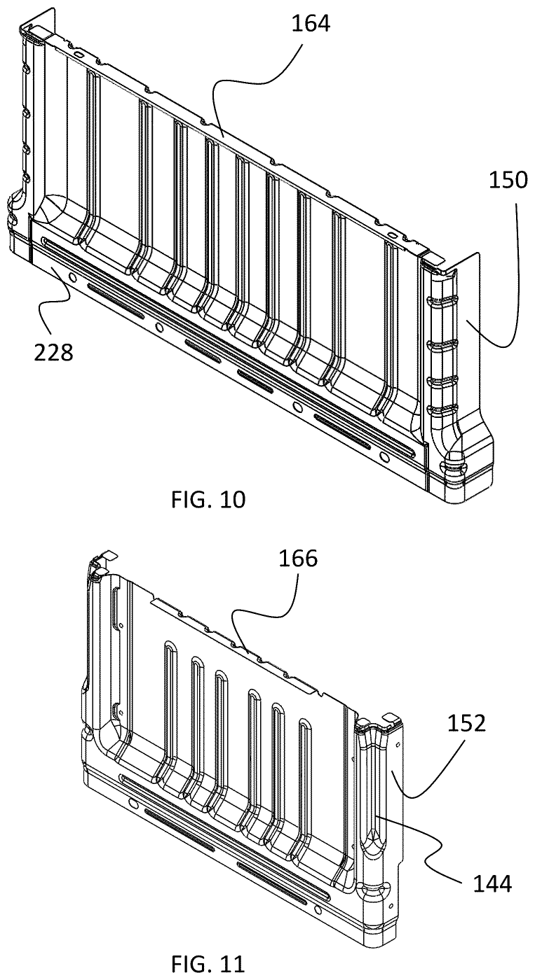

The upper sidewall 164 and end wall parts 166 of the metallic container body 110 are each formed from a sheet metal blank and can optionally be formed by stamping or drawing the sheet metal blank (see FIGS. 10 and 11). The rim portions 168 can equally be formed by stamping a sheet metal blank. The upper edge of the rim portions 168 is inwardly turned to form a lip 148 having one or more apertures or openings 149 for engagement with a grabber device of a load handling device. The rim portions 168 are configured such that they clip onto or snap fit onto the exterior of the upper sidewall 164 and/or upper end wall parts 166. To improve the structural integrity of the box-like structure of the metallic container body and to enable the upper sidewall and end wall parts to be fixed together, one or more connecting flanges 150, 152 are formed at opposing ends of the upper sidewall parts 164 and the upper end wall parts 166. The flanges 152 of the upper end wall parts 166 are configured to overlay adjacent connecting flanges 150 of the upper sidewall parts 164 when they brought together with the lower part 160 of the metallic container body 110 to form the box-like structure. For example, a connecting flange 152 of the upper end wall parts 166 is configured to overlay an adjacent connecting flange 150 from an upper sidewall part 164. This is clearly shown in FIG. 13. Each of the connecting flanges 150, 152 of an adjacent upper sidewall part or upper end wall part extends across a corner of the metallic container body 110 to strength the corner. Various fasteners known in the art can be used to fix the upper sidewall 164 and end wall parts 166 together at the corners of the metallic container body using their respective flanges. These include but are not limited to welding, e.g. spot welding, riveting, and/or use of an adhesive. In the particular embodiment of the present invention, the connecting flanges 150, 152 of the upper sidewall 164 and end wall parts 166 are fixed or connected together by a process called mechanical clinching. Clinching is similar to riveting but without the need for a separate rivet and involves plastically deforming the metal sheets by the use of a special punch and die to create a physical interlock between the sheet metal layers. To further improve the structural integrity of the box-like structure, the rim portion 268 mounted on the upper end wall parts 166 can optionally comprise a rim flange 254 at each corner which overlays each connecting flange 152 of the upper end wall part 166.

To enable the gripper elements of the grabber device to properly align with the apertures or openings 149 in the rim portion of the storage container, the metallic container body comprises a guide 144 at each of the corners of the box-like structure of the metallic container body 110 that extends vertically from the upper edge or rim of the storage container to at least partially along the height of the box-like structure of the storage container for accommodating the guiding pins or locating pins of the grabber device. As discussed above with reference to FIG. 6, the guides 144 are shaped to cooperate with the guiding pins or location pins of the grabber device so as to properly align the gripper elements 46 with the openings 149 in the rim portion 168 of the storage container. The guides 144 at the corners of the metallic container body are formed by elongated vertical depressions in the connecting flanges 150, 152 of the upper sidewall and/or end wall parts 164, 166. The elongated vertical depressions 144 can be formed by one or more bends in the sheet metal of the upper side wall 164 and/or upper end wall parts 166. In the particular embodiment of the present invention, the elongated vertical depressions 144 are formed in the connecting flanges 152 of the upper end wall parts 166 as shown in FIG. 11. The elongated vertical depressions 144 in the connecting flanges 152 of the upper end wall parts 166 are configured to overlay the connecting flanges 150 of the upper sidewall parts 164 at the corners of the box-like structure of metallic container body 110 when the upper sidewall parts 164 and upper end wall parts 166 are brought together as shown in FIG. 13. The overlaying connecting flanges 150, 152 of the upper sidewall parts 164 and upper end wall parts 166 provide the corners of the metallic container body 110 comprising two layers that overlap. This is in turn reinforces the corners of the metallic container body 110 for bearing the load from one or more storage containers being placed on top, particularly when the storage container comprising the metallic container body is placed in a stack of storage containers. Thus, there is rigidity through the corners of the metallic storage container 110 from the two-part corner structure shown in FIG. 13.

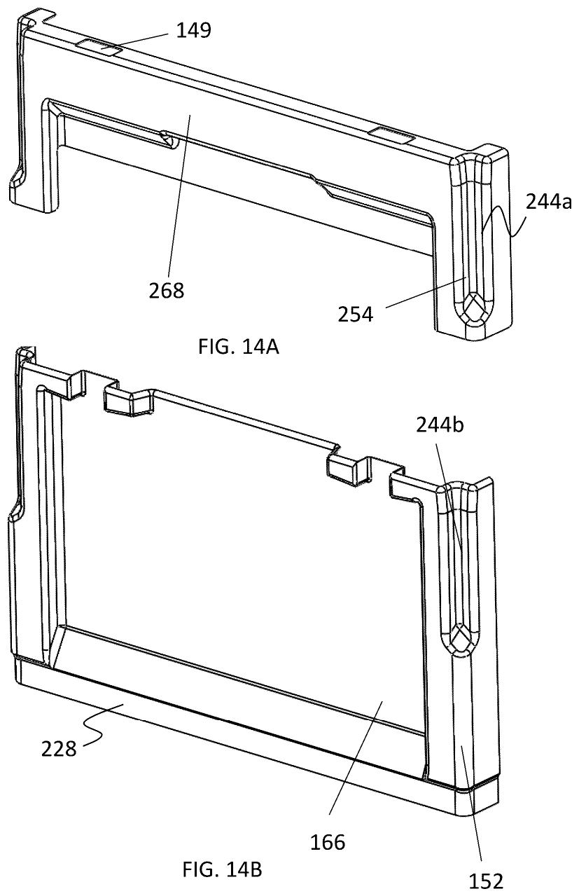

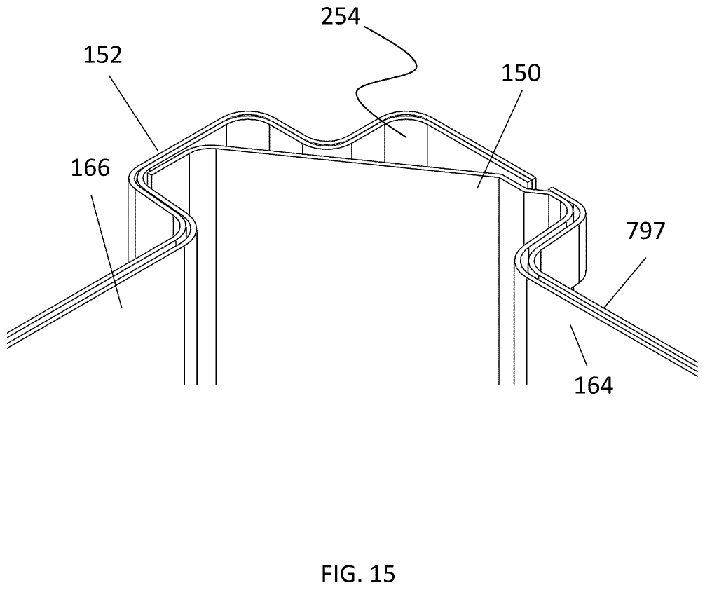

To further reinforce the corners of the storage container, the rim portion 268 mounted on the upper end wall parts 166 can optionally comprise a downwardly extending rim flange 254 at each corner which overlays each connecting flange 152 of the upper end wall part 166. Thus, instead of having a double skin of the metal container body at the corners of the storage container, the overlaying connecting flanges 150, 152 of the upper sidewall parts 164 and upper end wall parts 166 together with the overlaying the flange 254 of the rim portion 268 provide the corners of the metallic container body 110 with three overlapping layers. This is demonstrated in FIGS. 14(a and b), where FIG. 14a show the rim portion comprising downwardly extending rim portions 254 that are configured to cooperate with the opposing flanges of the end wall parts in the upper part of the storage container to increase the number of skins at the corners of the storage container from two skins as shown in FIG. 13 to three skins. Like the storage container discussed above, the opposing sidewalls 164 and end walls 166 of the storage container 110 can comprise one or more slots or openings or holes 149 to permit engagement with the gripper elements of the grabber device. To accommodate the guides for the locating pins 42 of the grabber device, the downwardly extending flanges 254 and the flanges 152 of the upper end wall parts 166 comprises a vertical depression 244a, 244b that cooperate when the rim portion 268 is assembled on the end wall part 166 as shown in FIGS. 14(a and b) when their respective flanges overlay to form the guide for the locating pins 42.

To increase the structural rigidity of the storage container one or more walls of the storage container can be embossed with one or more ribs 112. In the particular embodiment of the present invention shown in FIGS. 8 and 9, the walls of the lower and upper parts of the storage container are embossed with a plurality of ribs 112 to strengthen their respective walls. The orientation of the ribs depends on the direction of the load being applied to the walls of the storage container. As the walls of the storage container experiences loads in a substantially vertical direction when supporting one or more storage containers in a stack, the plurality of ribs 112 embossed in the sidewalls and end walls of the storage container extend in a substantially vertical direction (see FIGS. 8 to 11).

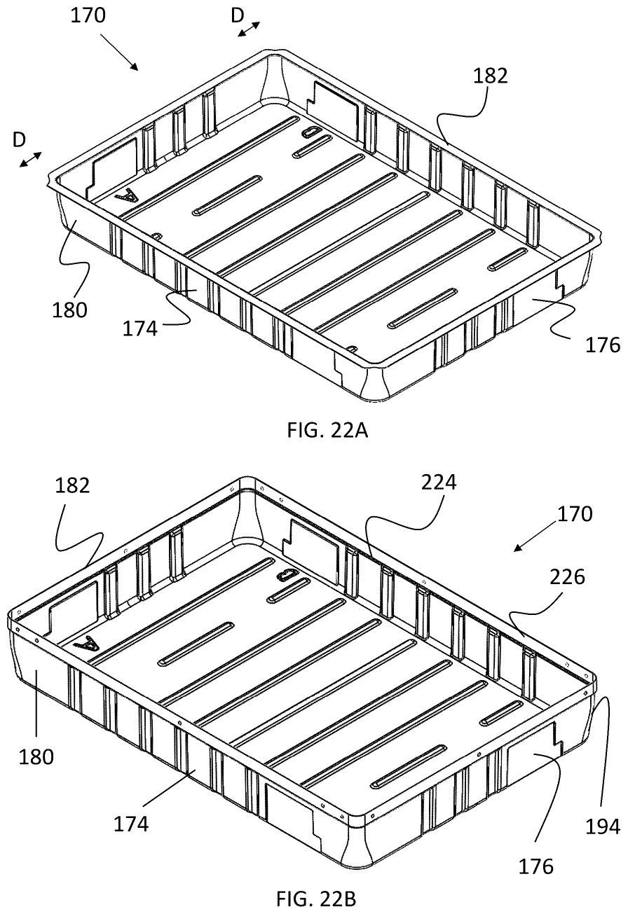

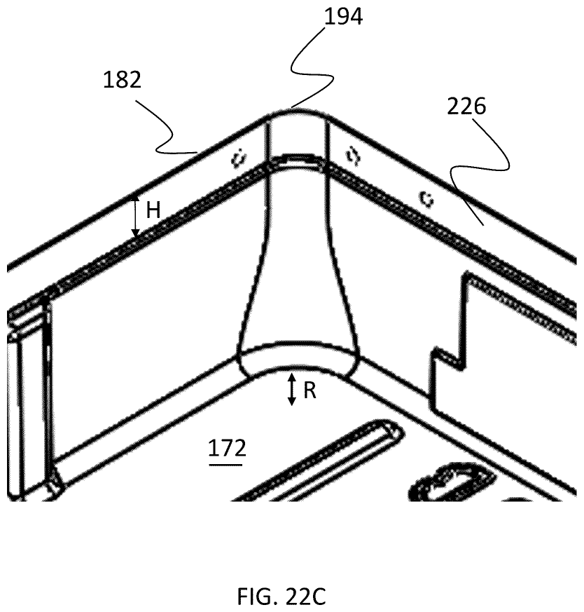

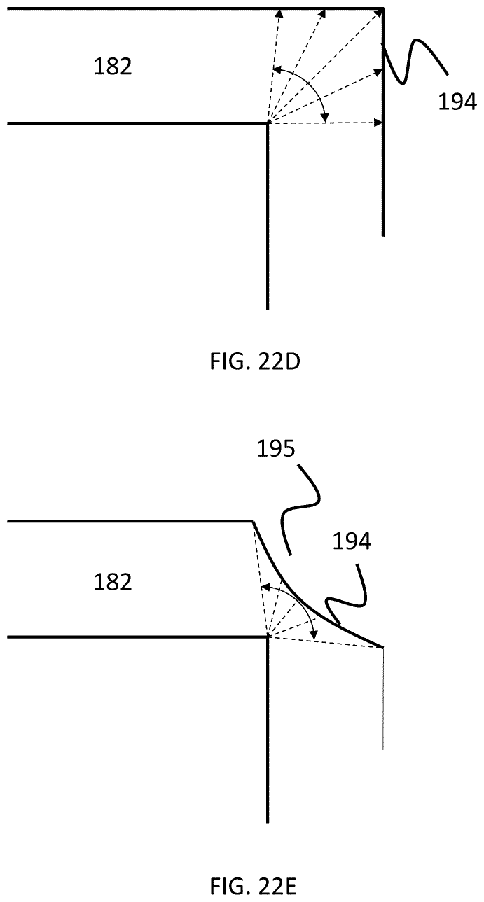

The problem with assembling the walls of the storage container from multiple stamped sheet metal blanks is making sure that the joints or the interface between adjacent walls of the storage container is leak tight. In the present invention, the lower part 160 is formed by drawing or stamping a single sheet metal blank to form a container (tray-shaped preform) or tray 170 comprising a container bottom wall 172 and upwardly standing opposing base sidewalls 174 and end walls 176 (see FIG. 22). To differentiate from the opposing sidewalls 164 and end walls 166 in the upper part 162 of the storage container, the upwardly standing opposing base sidewalls 174 and end walls 176 of the lower part of the storage container can be defined as a raised rim 180. The raised rim comprising base sidewalls 174 and base end walls 176 of the container. The sidewall 164 and end wall parts 166 in the upper part of the storage container are assembled together with the lower part to form a box-like structure according to an exemplary embodiment of the present invention. In comparison to the upper part of the storage container, it is important that the lower part of the storage container is leak proof when storing grocery items. To fabricate the lower part as a leak proof container, the lower part is ideally formed from a single sheet metal blank that is plastically deformed to form a tray-shaped preform 178 as shown in FIG. 17. The tray-shaped perform is shown in FIG. 17 comprising a raised rim 180 and a flange 182 extending outwardly around the peripheral open edge of the raised rim 180. For the purpose of definition, the raised rim 180 of the tray-shaped preform comprises the upwardly standing opposing base sidewalls 174 and end walls 176 of the lower part 160 of the storage container 110. The flange 182 is formed as a result of the stamping or drawing process as described further below.

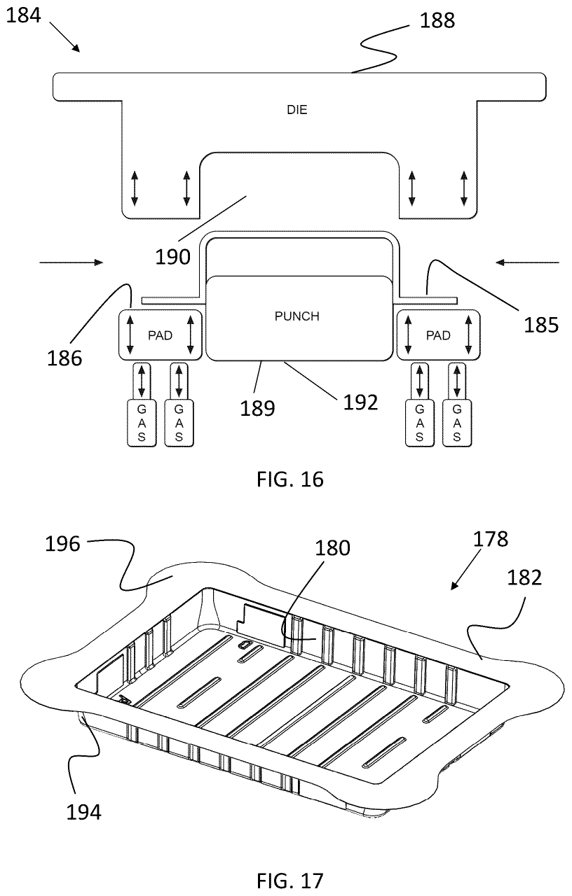

In accordance with an exemplary embodiment of the present invention, the lower part 160 of the storage container is formed from stamping or drawing a single sheet metal blank 185 in a single operation into a forming or drawing die 184 and involves stretching the sheet metal blank by the mechanical action of the forming or drawing die into the sheet metal blank. As shown in FIG. 16, the drawing die 184 comprises a holding die member 186, an upper die member 188 having a die cavity 190 and a lower die member 189 comprising a punch 192. The holding or clamping force of the holding die member 186 is controlled by controlling the pressure of gas applied to a pad 186. The punch 192 can be located on a die platen or member (not shown). However, the present invention is not limited to the upper die member 188 comprising the die cavity 190 and the lower die member 189 comprising the punch 192 and the reverse is applicable where the lower die member 189 comprises the die cavity 190 and the upper die member 188 comprises the punch 192. Operation of the drawing process involves bringing the upper and lower die members 188, 189 together so that the punch 192 forces the sheet metal blank 185 into the die cavity 190 to form a tray-shaped preform 178 as shown in FIG. 17.

During the drawing process, the punch 192 cooperates with the die cavity 190 to draw the ends of the sheet metal blank inward in the direction of the arrows. The peripheral stresses occurring during the drawing process make the flange 182 the critical region of the tray-shaped preform 178.

To prevent wrinkling of the flange 182 and to control the drawing process, the holding die member 186 applies pressure to the flange 182 to suppress wrinkling and control the sheet metal draw into the die cavity 190. The holding die member 186 can function independently of the punch 192 so that the holding die member 186 secures the periphery of the blank 185 to control the amount of the material of the blank being drawn into the die cavity 190. The tray-shape preform 178 is an intermediary step in the fabrication of the lower part of the storage container. In all cases above, the sheet metal blank is drawn by a single drawing process. During the drawing process, the sheet metal blank 185 undergoes superplastic deformation as the sheet metal is drawn into the die cavity 190. The degree of plastic deformation varies throughout the tray-shape preform 178 and is greatest at the corners 194 of the tray-shape preform 178. This is depicted by the irregular shape of the flange 182 at the corners 194 of the tray-shape preform 178 as these areas of the flange 182 undergo excessive stretching of the sheet metal 185 when being clamped in the holding die member (or blank holder) 186. For the purpose of definition in accordance with the present invention, the region of the sheet metal blank clamped in the holding die member during the drawing process can be termed flash 196 and represents the region of sheet metal blank that extends outwardly around the peripheral open edge of the rim of the tray-shaped preform 178, i.e. the flash 196 extends outwardly in a substantial perpendicular direction to the walls of the tray-shaped preform. The flash 196 comprises excessive material attached to the container 170. To convert the tray-shaped preform 178 into the container 170 (as shown in FIG. 22b) forming the lower part 160 of the storage container 110, the flash 196 is usually removed, e.g. by trimming.

However, to form the container 170 with the correct depth to provide the required leakage capacity, drawing or stamping the container 170 from a single sheet metal blank 185 alone will largely depend on the ability of the metal to plastically deform so as to conform to the shape of the die cavity without rupturing or have localised thinning, i.e. depends on the tensile strength of the metal. This is because stamping or drawing a sheet metal blank takes advantage of the metal's superplasticity or the ability to be strained past its failure point at a given operating temperature. The more ductile the metal, the greater the ability of the sheet metal to plastically deform to the shape of the die cavity. Not only should the metal have sufficient ductility to be able to plastically deform to the shape of the die cavity but the metal should be sufficiently corrosion resistant to hold grocery items. An example of a metal type used in the industry to hold food items is stainless steel. However, stainless steel is less easy to work than other corrosion resistant steels such as galvanised steel. In general, galvanised steel is more ductile and easier to work than stainless steel since the inner core of the galvanised steel can be selected from various ductile steels or iron and the zinc coating protects the steel or iron beneath it from corrosion. In the particular example of the present invention, the metal type in the forming of the lower part 160 of the storage container comprises galvanised steel due to its ability to be easily worked. In the particular embodiment of the present invention shown in

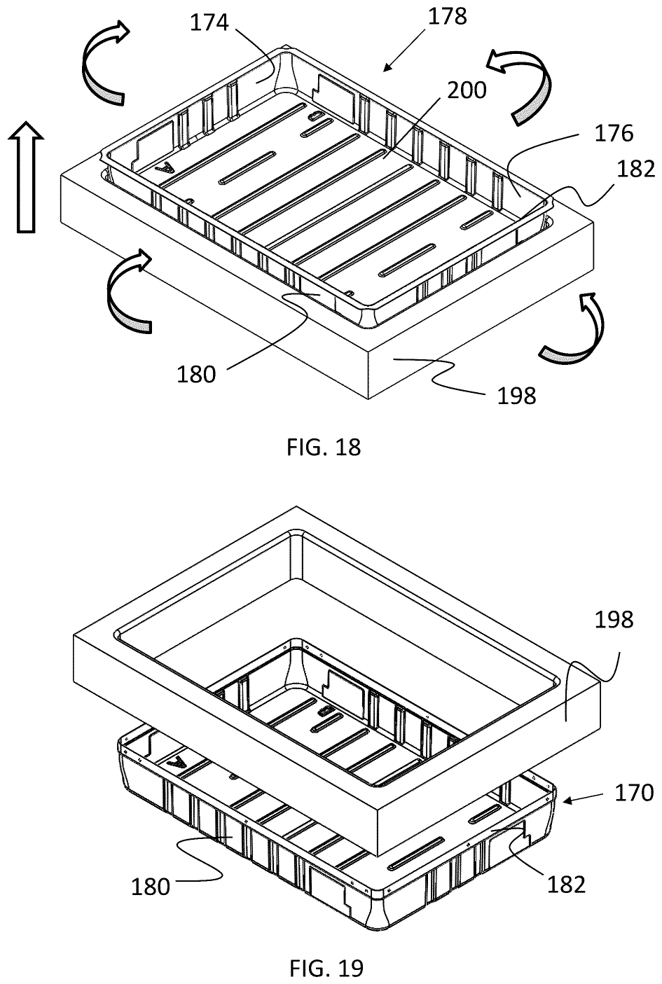

FIGS. 18, 19 and 22(a and b), the container in the lower part 160 is formed as a shallow container having a depth less than the length and width of the container. In the particular embodiment of the present invention, the container is formed as a shallow container 170 having dimensions of 448 mm (long)×648 mm (width)×93 mm (height).

To increase food safety, the storage container 110 can be lined with a liner as discussed above that is compliant to food safety standards. However, the present invention is not limited to galvanised steel and other metal types that are corrosion resistant and have the necessary ductility to be plastically deformed into the lower part of the storage container are applicable in the present invention. Optionally, the upper part 162 of the storage container 110, e.g. the sidewalls and/or end walls, can be formed from a plurality of sheet metal blanks, each of the plurality of sheet metal blanks comprising galvanised steel.

Despite galvanised steel being sufficiently ductile to be drawn into a container 170, the drawing process has limitations when cold working the sheet metal blank as the ductility of the steel decreases at lower temperatures to the extent that the leakage capacity and thus, depth of the container formed by the drawing process would not be reached by simply drawing the sheet metal blank in a single process. The more complex the shape of the container, in this case, the tighter the angle at the corners 194 of the container 170, the more strain that the sheet metal undergoes when being plastically deformed in the drawing process to the extent that the rupture point is reached before the steel can be fully formed into the die cavity. This results in either localised thinning of the sheet metal or tearing of the sheet metal, particularly around the corners 194 of the container 170. However, the tighter the angle at the corner 194 of the container 170 in sense the closer the angle approaches 90° at the corners, the improved chances that the storage container formed from the container 170 can be stackable without any two of the storage containers getting stuck. In accordance with the present disclosure, each of the corners of the container 170 has a radius, R, in the range of 5 mm to 10 mm, preferably in the range 5 mm to 8 mm (see FIG. 22(c)). Considering that a typical grid framework structure can hold hundreds or even thousands of storage containers, cold working the sheet metal blank would be the most cost effective and efficient process in the manufacture of the lower part 160 of the storage container 110. However, the limitations in the ductility of the sheet metal blank when cold working the sheet metal into a tray-shaped preform 178 and considering that fewer drawing operations are preferable to draw the sheet metal blank (preferably, a single drawing operation) has meant that the leakage capacity and thus, depth of the shallow container cannot be reached by drawing the sheet metal blank into a tray-shaped preform alone.

In accordance with the present invention, the leak capacity of the container is increased by an additional process of inwardly turning the flange 182 extending outwardly around the peripheral open edge of the raised rim 180 towards the mouth 200 of the tray-shaped preform 178 such that the inwardly turned flange 182 extends in the same direction as the walls of the container, i.e. forms part of the walls of the container. This is schematically shown by the arrows in FIG. 18. This has the effect of increasing the depth of the container and thus, leakage capacity of the container 170 without the need to increase the depth by the mechanical action of the drawing process alone. The depth and thus, leak capacity of the container can be controlled by controlling the width D of the flange 182 (see FIG. 22a). The greater the width of the flange 182, the greater the depth of the container and vice versa. In the particular example of the present invention shown in FIG. 22a, the flange has a width, D, of about 20 mm and the height of the raised rim 180 is about 75 mm. This gives a total height of 95 mm when the flange is turned and thus, an increased leakage capacity.

A wiping die or wiping edge bending die 198 known in art can be used to inwardly turn the flange 182 so that it lies in a vertical plane as schematically shown in FIGS. 18 and 19. The tray-shape preform 178 is positioned in the wiping die 198 such that the flange 182 extends across the wiping die 198. The wiping die 198 is moved relative to the tray-shaped preform 178 towards the flange 182 such that the flange that extends across the wiping die is bent in an inward direction as the wiping die travels past the flange. Inwardly bending the flange by the wiping die is schematically shown in the drawings in FIGS. 18 and 19 and shows the wiping die 198 moving in an upward direction shown by the arrow relative to the tray-shaped preform 178. In the particular embodiment of the present invention shown in FIGS. 18 and 19, the wiping die 198 is formed as a ring shaped tool so as to surround the walls 174, 176 of the container 170. This has the resultant effect of turning the flange 182 towards the mouth 200 of the container in a single operation such that the flange lies in a substantially vertical plane. For the purpose of the present invention, the term inwardly turning covers the action of bending or raising the flange at the junction or connection between the flange and the walls 174, 176 of the container as shown by the curved arrows in FIG. 18, i.e. at the rim of the tray-shaped preform. The use of a ring shaped wiping die 198 allows the flange 182 to be turned in single operation of the wiping die. The resultant container 170 is a container with a raised flange 182 increasing the depth of the container 170 as shown in FIG. 22b. The turned flange 182 also defines a connection surface for attaching the upper part of the storage container comprising the sidewalls 164 and end walls 166.

Cold working complex shapes, in particular the corners with a tight or small radii, into a single sheet metal blank is only achievable to a certain depth of the tray-shaped preform before the rupture point of metal is reached, beyond which the sheet metal will start to rupture. The two stage operation of stamping or drawing a sheet metal blank into a tray-shaped preform 178 followed by raising or inwardly turning the flange 182 to define the container 170 with increased height enables complex shapes, in particular corners with a tight or small radii, having a predefined depth or leakage capacity to be formed within the sheet metal blank by cold working alone. As a result, the depth and thus, the leakage capacity of the resultant shallow container can be controlled by the width, D, and shape of the flange. The resultant effect of the two stage operation on the tray-shaped preform to form the container is exemplified in FIGS. 22(a and b). FIG. 22a is an example of the tray-shaped preform prior to inwardly turning or raising the flange and FIG. 22b shows the container being formed by turning or raising the flange such that the flange lies in a substantially vertical plane.

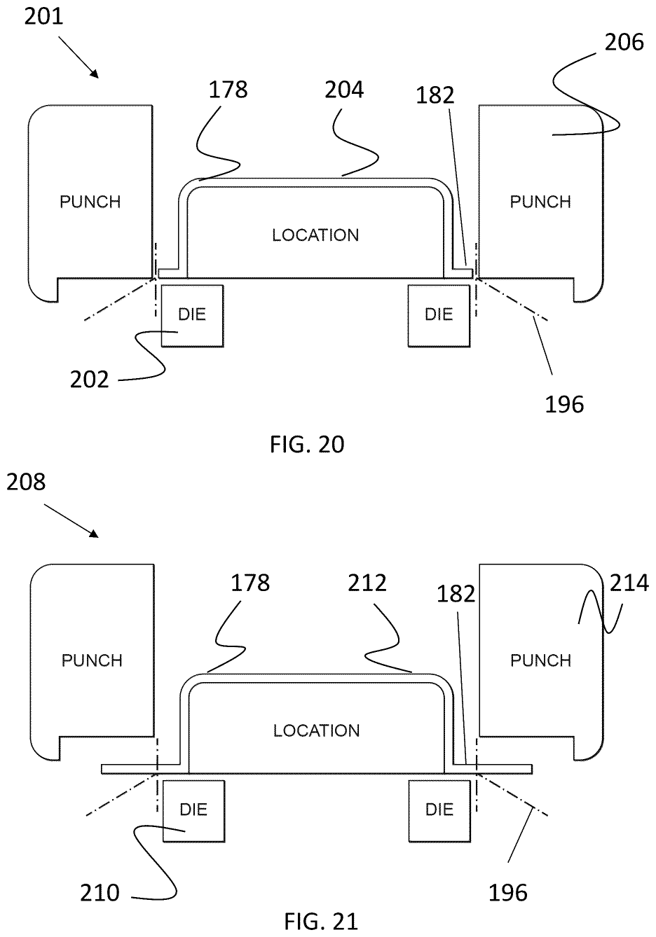

To control the depth of the container 170, the flange 182 is formed by trimming the flash 196 of the tray-shape preform 178 to a predetermined width and/or shape. Once the stamping or drawing process is complete, the tray-shaped preform can be removed from the drawing die and transferred to a trim cutting die 201 shown in FIG. 20 to trim the flash to form the flange 182 having a predetermined width, D. In accordance with an example of the present invention, the stamping or drawing process produces a tray-shaped preform having a depth of about 70 mm. To provide a container with a depth of 93 mm, the flange has a predetermined width, D, of 20 mm. The depth of the tray-shaped preform is not limited to 70 mm and can be any depth within the limitations of the stamping or drawing process reaching the rupture point of the sheet metal, for example, the depth may be 50 mm, 60 mm, 80 mm, 90 mm or 100 mm. Equally, the width of the flange is not limited to being 20 mm and can be any width depending on the required depth of the final container, for example, the flange width may be 10 mm, 15 mm, 25 mm or 30 mm. In the particular embodiment of the present invention, the sheet metal blank is formed into a shallow container. However, the width, D, of the flange can be larger than the width and/or length of the preform such that when the flange is turned, the resultant container is formed as a deep container.

Trim cutting the flash 196 is performed by holding the tray-shaped preform 178 between a pad 202 and a location die member 204 as shown in FIG. 20 so that the flash 196 protrudes from the location die member 204 and pad 202. The flash 196 is trimmed by sliding a trim cutting punch 206 across the face of the location die member 204 and pad 202 as shown in FIG. 20.

The spacing between the trim cutting punch 206 and the face of the location die member 204 and the pad 202 determines the width of the resultant flange 182. An optional shaping operation can be included prior to the flash trimming operation discussed above with reference to FIG. 20. As discussed above with reference to FIG. 17, the flash 196 has an irregular shape due to the excessive plastic deformation of the sheet metal in the blank holder in the vicinity of the corners of the tray-shape preform 178.

In addition to trimming the flash to a predetermined width discussed above with reference to FIG. 20, the flash can be shaped by removing the excessive sheet metal around corners of the flash 196. Thus, once the stamping or drawing process is complete, the tray-shaped preform 178 can be removed from the drawing die and transferred to a trim corner cutting die 208 as show in FIG. 21. Corner cutting of the flash 196 is performed by holding the tray-shaped preform between a pad 210 and a location die member 212 so that the flash 196 protrudes from the location die member 212 and pad 210. The corners of the flash 196 is trimmed by sliding a trim cutting punch 214 across the face of the location die member 212 and the pad 210 as shown in FIG. 21. The surface area of the flange 182 provides a connection surface 226 for attaching to the sidewalls and/or end walls in the upper part of the storage container as further discussed below. Maximum contact surface area is achieved by ensuring that there is essentially a substantially flat surface for attaching to the sidewalls and/or end walls in the upper part of the storage container. Ideally, the height, H, of the connection surface 226 extending around the periphery of the container 170 is substantially equal to the width of the flange (see FIG. 22(b)). However, the problem with turning the flange 182 once trimmed is the risk of wrinkling of the flange particularly at the corners of the flange resulting in an undulating surface and thereby, limiting the maximum contact surface area when connecting to the sidewalls and/or end wall in the upper part of the storage container. This is best explained by the schematic drawing of a corner 194 of the flange 182 shown in FIGS. 22(d and e). In FIG. 22(d), the corner 194 of the flange has a profile that is substantially 90° angle. During turning of the flange when increasing the depth of the container 170 in the lower part of the storage container, the sheet metal undergoes compression shown by the dashed arrow in FIG. 22(d). Compression of the sheet metal at the corners of the flange is relieved by a combination of wrinkling of the sheet metal and plastic flow of the material. Notches 195 may be cut in the corners 194 of the flange to prevent wrinkling of the flange at the corners when the flange is turned or raised by the wiping die. Material flow as a result of compression of the metal when turning the flange is, thus, accommodated by the notches 195 at the corners of the flanges as demonstrated by FIG. 22(e). The notch provides a space or area for the metal to flow when being turned thereby preventing wrinkling at the corners of the container. As material flows outwardly during turning of the flange as shown by the dashed lines in FIG. 22(e), the profile of the container at the corner can be restored such that the height, H, of the connection surface around the periphery of the container or tray-shaped preform 170 is substantially uniform as shown in FIGS. 22(b and c).

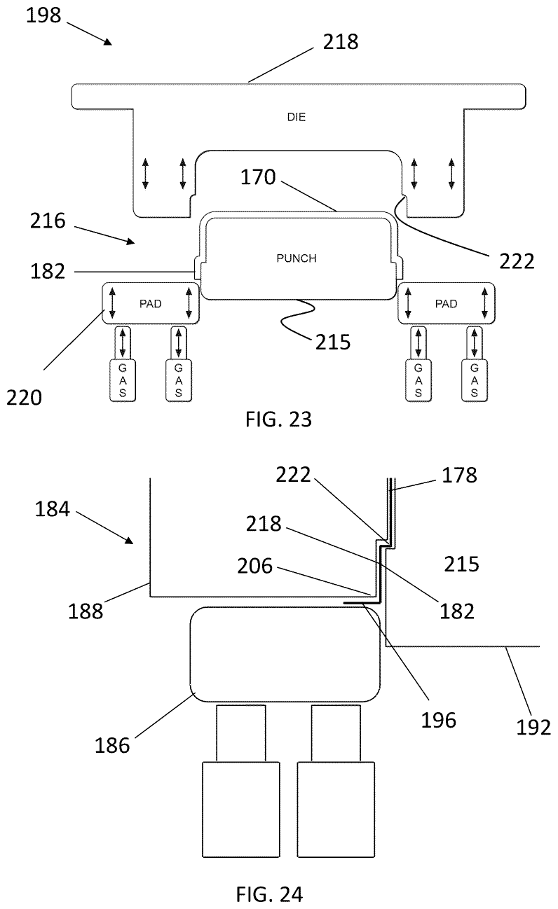

As discussed above with reference to FIGS. 18 and 19, a wiping or edge bending die 198 is used to inwardly turn or raise the flange so that the flange lies in a substantially vertical plane. Once the flash 196 has been trimmed to form the flange 182 having a predetermined width, the trimmed tray-shape preform can be removed from the location die member of the trim cutting die 201 and transferred to a wiping die 198 comprising a location die member 215 and a wiping die member 218 as shown in FIG. 23 where the flange 182 is inwardly bent to increase the depth of the tray-shaped perform. Wiping die bending is performed by supporting the sheet metal blank on the location die member 215 such that the flange 182 protrudes from the location die member 215. Turning or bending of the flange 182 is performed by sliding the wiping die member 218 across the face of the location die member 215 so as to cause the protruding flange to be inwardly turned as shown in FIG. 23. The reverse is plausible where the location die member 215 supporting the tray-shaped preform functions as a punch and is moved towards the wiping die member 218 to turn the flange 182 protruding from the location die member 215.

Whilst separate dies are described above for the different manufacturing steps of the container in lower part of the storage container, one or more of the manufacturing steps of the lower part 160 of the storage container can be carried out using the same tool or die. For example, one or more of the manufacturing steps of the lower part of the storage container can share the same tool or die. To share the same tool amongst a plurality of the manufacturing steps of the lower part of the storage container, one or more of the dies can be integrated into the drawing die 184 but share the same location die member 192 for supporting the tray-shaped preform 178 whilst the stamping operation is being carried out. The one or more dies can be the wiping die member 218 and/or the trim cutting punch 206 and/or the corner cutting die 208. In the particular embodiment of the present invention shown in FIG. 24, the wiping die member 218 and the trim cutting punch 206 are integrated into the wiping die 184, i.e. integrated into a wall of the upper die member 188 comprising the die cavity 190. FIG. 24 is a schematic drawing of a section of the drawing die 184 incorporating the wiping die member 218 and the trim cutting punch 206. To share the same drawing die 184, the punch 192 of the drawing die 184 can function as a location die member for supporting the tray-shaped preform 178 during the subsequent operations. This removes the need to transfer the tray-shaped preform to another die when carrying a different stamping operation. A problem of repeatedly transferring the tray-shaped preform when carrying out a different stamping operation is the need to repeatedly remove the tray-shaped preform from the location die member. Each time the tray-shaped preform is removed from the location die member, there is the risk of deforming the tray-shaped preform thereby reducing the structural integrity of the tray-shaped preform, particularly the bottom wall of the tray-shaped preform. In the particular embodiment of the present invention, the tray-shaped preform 178 formed from the drawing process remains on the punch 192 after the drawing operation. As the wiping die member 218 is integrated into the drawing die 184, the flange 182 is subsequently turned by moving the upper die member 188 towards the punch 192. This could be followed by trimming the flash or excessive sheet metal by the trim cutting punch 206 integrated into the die cavity 190. Thus, the container 170 can be formed by a series of stamping operations of the punch 196 and/or the upper die member 188, each stamping operation completing a different operation of the container. In both cases, the tray-shaped preform 178 is held in the holding die member 186 of the drawing die 184.

In the particular embodiment of the present invention as shown in FIG. 23, the wiping die member 218 is shaped to include a step 222 in the flange in addition to turning the flange. This is demonstrated in the schematic drawing of the shallow container shown in FIG. 20b. As discussed above, the separate sidewall and end wall parts 164, 166 in the upper part 162 of the storage container are assembled together with the lower part to form a box-like structure of the metallic container body. Stamping a step 224 in conjunction with inwardly turning the flange provides a connection surface 226 in the container for attachment of the upper part to the lower part of the storage container. In addition to joining the sidewalls and end walls 164, 166 together in the upper part 162 of the storage container together via their respective connecting flanges 150, 152 as discussed above with reference to FIGS. 10 and 11, the separate sidewalls and end walls 164, 166 are assembled onto the container by joining the sidewalls and end walls to the turned flange via their respective connection surface 226 as shown in FIGS. 8 and 9. The turned flange provides an area in the lower part of the storage container for joining the sidewalls and end walls to the container. The sidewalls and end walls in the upper part of the storage container can be formed with a corresponding connecting or connection surface 228 for joining to the turned flange in the lower part of the storage container (see FIG. 10). The step 224 in the flange 182 also provides a surface for supporting the edge of the sidewalls 164 and end walls 166 when the sidewalls and end walls are offered up to the lower part of the storage container. Various fasteners can be used to join the sidewalls and end walls of the upper part of the storage container to the inwardly turned flange of the shallow container. These include but are not limited to welding, e.g. spot welding, riveting, and/or use of an adhesive. The sidewalls 164 and end walls 166 can be inclined outwardly relative to the raised rim 180 of the container such that the walls of the storage container taper outwardly.

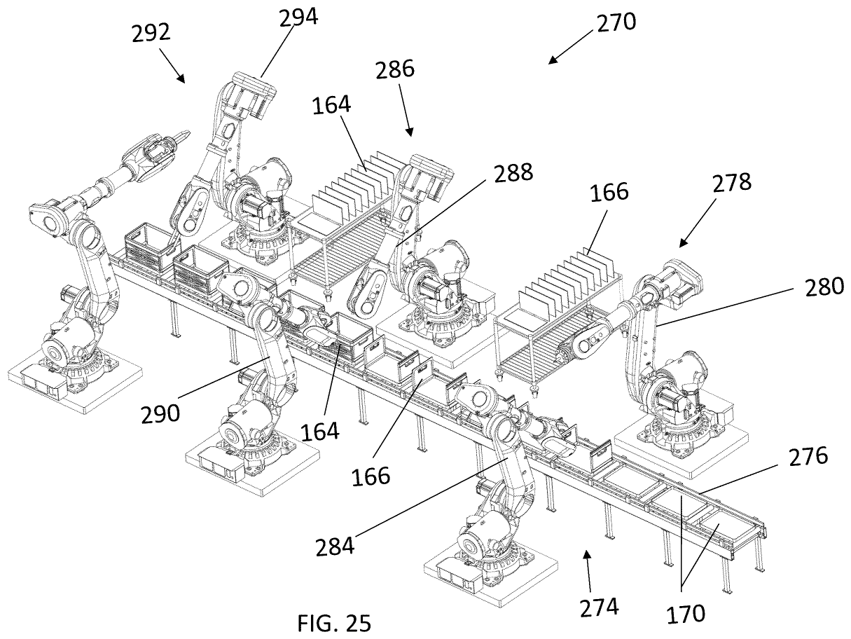

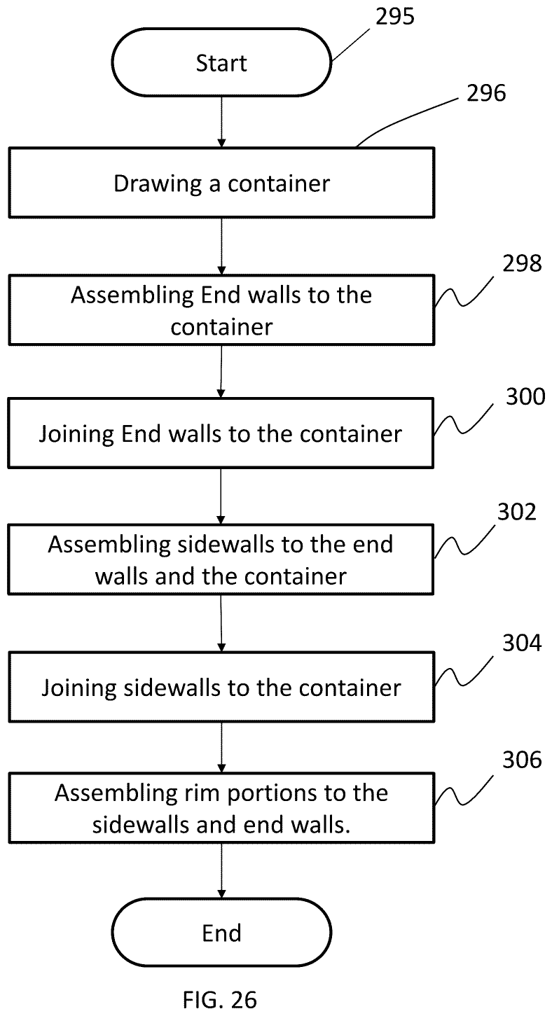

Separately forming the container into a shallow container and subsequently assembling the sidewalls and end walls to the shallow container to form the storage container according to an exemplary embodiment of the present invention lends itself kindly to automation of the assembly of the storage container according to the present invention. FIG. 25 in conjunction with FIG. 26 can be used as an example of the automation of the manufacturing process 270 of the storage container according to the present invention. Various assembly stations can be used to assemble the different parts of the storage container discussed above. Whilst not shown in FIG. 25, the process begins with a drawing station for drawing or stamping the shallow container. This is shown as step 296 in the flowchart in FIG. 26. The two stage operation of drawing a tray-shaped preform followed by inwardly turning or bending the flange discussed above can be automated to mass manufacture a plurality of shallow containers 170 forming the lower part of the storage container. The formed shallow containers are fed into to an assembly area 274 shown in FIG. 25 comprising a plurality of assembly stations for assembling the sidewalls 164 and end walls 166 of the storage container to the shallow container 170. In the particular example of the automation process shown in FIG. 25, the shallow containers 170 are fed sequentially to the different assembly stations in the assembly area 274 via a conveyor system 276. A robotic arm at the different assembly stations can be instructed to perform one or more tasks detailed in the flowchart shown in FIG. 26 when assembling the storage container according to the present invention. As shown in FIG. 25, a first assembly station 278 comprises a first robotic arm 280 instructed to assemble the end walls 166 to the shallow container 170 during the first, preform stage of the storage container to form a preform storage container 282. This is shown as step 298 in FIG. 26. At the first assembly station 278, a second robotic arm 284 can be instructed to join the end walls to the shallow container, e.g. by spot welding. This is shown as step 300 in FIG. 26. Once the end walls 166 are joined to the shallow container 170, the preform storage container 282 is fed to a second assembly station 286 where a third robotic arm 288 can be instructed to assemble the sidewalls 164 to the end walls 166 and the shallow container 170. This is shown as step 302 in FIG. 26. The step of turning the flange 182 of the shallow container 170 to define a connection surface 226 enables the walls (sidewalls and end walls) of the storage container to be easily assembled onto the shallow container 170. At the second assembly station 286 a fourth robotic arm 290 can be instructed to join the sidewalls 164 to the shallow container 170 via the connection surface of the turned flange 182. This is shown as step 304 in FIG. 25. The first and second stations 278, 286 can share the same robotic arm for respectively joining the end walls 166 and sidewalls 164 to the shallow container 170 or alternatively, the first and second stations 278, 286 can each comprise a separate robotic arm for joining the end walls 166 and sidewalls 164 to the shallow container 170. An additional third assembly station 292 comprising a fifth robotic arm 294 can be instructed to assemble the rim portions 168 to the sidewalls 164 and end walls 166 to complete the assembly of the storage container. This is shown as step 306 in FIG. 26.

In comparison to plastic storage containers currently in use to store goods, the storage container formed from an assembly of stamped or drawn sheet metal blanks not only fulfils the criteria of being fire resistant set out in point E above but the leak proof lower part with tight corners also fulfils the criteria set out in points A to D above. The ability to form the container by the two stage process of stamping or drawing a single sheet metal blank to form a tray-shaped preform followed by turning the flange so that the flange extends in the same direction of the raised rim of the tray-shape preform provides a container with tight corners for stacking in a storage column and to a predetermined depth with the required leak capacity. Having tight corners fulfils the criteria set out in point D of being able to be stacked and the increased depth of the shallow container fulfils the criteria set out in point C to providing sufficient leak capacity to capture leaks without contaminating the contents of other storage containers in a stack. Another advantage of separately forming the lower part or base portion to the upper part of the storage container is that it allows different thicknesses of sheet metal to be used for the lower part than for the upper part to improve the structural integrity of the assembled storage container. For example, a thicker sheet metal blank can be used for the lower part of the storage container when forming the container (or shallow container) than the upper part of the storage container. Whilst the preferred metal type in the fabrication of the storage container discussed above is galvanised steel, the present invention is not limited to fabricating the storage container from galvanised steel. The ability to increase the depth of the container in the lower part of the storage container by the two stage process discussed above, allows other corrosion resistant metal types to be used in the fabrication of the storage container such as stainless steel. Optionally, different corrosion resistant metals can be used for the upper and lower parts of the storage container, e.g. galvanised steel for the lower part due to its formability and stainless steel for the upper part of the storage container.

Whilst the preferred embodiments of the present invention have been described in detail above, it should be understood that various modifications of the storage container encompassing different features described above, and different combinations of features described in relation to different embodiments, are applicable within the scope of the present invention as defined in the claims.

1. A method of manufacturing a storage container for storage in a stack in a grid framework structure comprising a plurality of storage columns, each of the plurality of storage columns being configured to store a stack of storage containers, the method comprising the steps of:
A) forming a lower part of the storage container by the steps of:
i) stamping or drawing a sheet metal blank into a drawing die to form a tray-shaped preform comprising a base with a raised rim and a flange;
ii) turning the flange to define a connection surface that extends in the same direction as the raised rim of the tray-shaped preform to form a container having a predefined depth;
B) forming an upper part of the storage container by the step of:
iii) stamping sidewalls and/or end walls from one or more separate sheet metal blanks;
C) attaching the lower part to the upper part by attaching the sidewalls and end walls to the connection surface of the container.

2. The method of claim 1, wherein the drawing die comprises a holding die member, an upper die member and a lower die member, at least one of the upper and lower die members comprising a punch and the opposite die member comprising a die cavity.

3. The method of claim 2, wherein the method further comprises the step of using the holder die member with the punch to control the amount of the sheet metal blank being drawn into the die cavity.

4. The method of claim 2, wherein the flange is turned by a wiping die comprising a location die member and a wiping die member, and wherein the method further comprising the steps of:
i) holding the pre-shaped preform in the location die member such that the flange extends outwardly from the location die member;
ii) moving the wiping die member relative to the location die member to turn the flange.

5. The method of claim 4, wherein the wiping die member is ring shaped.

6. The method of claim 4, wherein the wiping die member is substantially rectangular.

7. The method of claim 4, wherein the wiping die member is integrally formed with the drawing die.

8. The method of claim 4, wherein the tray-shaped preform comprises flash extending from the raised rim of the tray-shaped preform and the method further comprises the step of trimming the flash to form the flange by a trim cutting die comprising a trim cutting punch and a location die member for supporting the tray-shaped preform, wherein the flash is trimmed by moving the trim cutting punch relative to the location die member to form the flange.

9. The method of claim 8, wherein the trim cutting punch is integrally formed with the drawing die.

10. The method of claim 8, wherein the method further comprises the step of trimming a corner of the flash by a trim corner cutting die comprising a corner cutting punch and a location die member for supporting the tray-shaped preform, wherein the corner of the flash is trimmed by moving the corner cutting punch relative to the location die member.

11. The method of claim 10, wherein the step of trimming the corner of the flash by a trim corner cutting die comprises the step of forming a notch in the corner of the flash.

12. The method of claim 10, wherein the corner cutting punch is integrally formed with the drawing die.

13. The method of claim 1, wherein the flange extends outwardly around the peripheral open edge of the raised rim and the flange is turned by inwardly turning the flange so that the flange extends in the same direction as the raised rim of the tray-shaped preform.

14. The method of claim 1, wherein the container in the lower part of the storage container is a shallow container.

15. The method of claim 1, further comprising the method of stamping a step into the flange.

16. The method of claim 1, wherein the sidewalls and end walls are attached to the connection surface by welding.

17. (canceled)

18. The method of claim 1, wherein each of the sidewalls and/or end walls of the upper part of the storage container comprises one or more openings or depressions for engagement with a grabber device of a load handling device.

19. The method of claim 1, wherein the tray-shaped preform is stamped or drawn from the sheet metal blank comprising galvanised steel.

20. A storage container for the storage of one or more items in a storage and retrieval system comprising a track system comprising a first set of parallel rails or tracks and a second set of parallel rails or tracks running transversely to the first set of parallel tracks in a substantially horizontal plane to form a grid pattern comprising a plurality of grid spaces or grid cells and a plurality of stacks of storage containers located beneath the track system and wherein each stack of the plurality of stacks of storage containers occupies a single grid space or grid cell, the storage container comprising a metallic container body formed by the method as defined in claim 1.

21. (canceled)

22. A storage and retrieval system comprising:
i) a grid framework structure comprising a plurality of storage columns for the storage of one or more stacks of storage containers and a track system comprising a plurality of tracks arranged in a grid pattern comprising a plurality of grid cells, the track system being arranged above the plurality of storage columns such that each of the plurality of storage columns is arranged below a respective grid cell of the track system;
ii) one or more stacks of storage containers, wherein at least one of the storage containers in the one or more stacks of storage containers being formed by the method as defined in claim 1;
iii) a plurality of load handling devices for lifting and moving storage containers stacked in the one or more stacks, the plurality of load handling devices being remotely operated to move laterally on the track system above the storage columns to access the storage containers through the grid cells, each of said plurality of load handling devices comprising:
a) a wheel assembly for guiding the load handling device on the track system;
b) a container-receiving space located above the track system; and
c) a lifting device arranged to lift a storage container from a stack into the container-receiving space.
